(19) United States
(12) Patent Application Publication
(10) Pub. No.: US 2025/0277960 A1
(43) Pub. Date: Sep. 4, 2025

(54) OPTICAL CAMERA LENS ASSEMBLY

(71) Applicant: ZHEJIANG SUNNY OPTICS CO., LTD, Yuyao City (CN)

(72) Inventors: Jiake ZHANG, Yuyao City (CN); Yu Zhou, Yuyao City (CN); Quanfeng Yang, Yuyao City (CN); Sixin Wang, Yuyao City (CN); Bian Zhang, Yuyao City (CN); Xiancui Ding, Yuyao City (CN); Lingbo He, Yuyao City (CN); Fujian Dai, Yuyao City (CN); Liefeng Zhao, Yuyao City (CN)

(73) Assignee: ZheJiang Sunny Optics Co., Ltd, Yuyao City (CN)

(21) Appl. No.: 18/978,601

(22) Filed: Dec. 12, 2024

(30) Foreign Application Priority Data
Mar. 4, 2024 (CN) 202410246347.8

(51) Int. Cl. G02B 13/00; G02B 9/64; G02B 13/06; G03B 17/12

(52) U.S. Cl. CPC G02B 13/0045; G02B 9/64; G02B 13/06; G03B 17/12

(57) ABSTRACT

An optical camera lens assembly is provided. An implementation of the optical camera lens assembly may comprise a lens barrel, seven lenses and at least one spacing piece. The the at least one spacing piece comprises a first spacing piece. Half of a maximal field-of-view Semi-FOV of the optical camera lens assembly and a maximal height L of the lens barrel satisfy: 0.5<TAN(Semi-FOV)/L<0.8. A spacing distance EP01 between an object-side end surface of the lens barrel and the first spacing piece, an outer diameter D1s of an object-side surface of the first spacing piece, an effective focal length f1 of the first lens, and a maximal effective radius DT12 of an image-side surface of the first lens satisfy: −2.5<EP01*D1s/(f1*DT12)<−1.0.

### CROSS-REFERENCE TO RELATED APPLICATIONS

This application claims the priority from Chinese Patent Application No. 202410246347.8, filed in the National Intellectual Property Administration (CNIPA) on Mar. 4, 2024, the contents of which are hereby incorporated by reference in their entirety.

### TECHNICAL FIELD

The present disclosure relates to the field of optical imaging device technology, and specifically to an optical camera lens assembly.

### BACKGROUND

With the increase of the requirements of users on the capabilities of mobile phone cameras, a capability to have a wider angle and take clearer photos becomes one of the important reasons for the users to choose a smartphone. In order to meet the needs of the users, an ultra-wide-angle optical camera lens assembly is usually equipped to meet a wide shooting range. Since an optical camera lens assembly needs to be applied to a smartphone, and the smartphone is usually small in size, the optical camera lens assembly needs to further meet the requirements for miniaturization. However, the stray light of the current miniaturized ultra-wide-angle lens assemblies is particularly serious, and the increase in stray light will affect the shooting quality of the optical camera lens assembly.

In other words, the optical camera lens assembly in the prior art has a problem that the stray light is serious when the optical camera lens assembly satisfies the ultra-wide angle and the miniaturization.

### SUMMARY

The main purpose of the present disclosure is to provide an optical camera lens assembly, to solve the problem of serious stray light in the case of ultra-wide angle and miniaturization of the optical camera lens assembly in existing technology.

To realize the above described purpose, an aspect of the present disclosure provides an optical camera lens assembly. The optical camera lens assembly includes a lens barrel, seven lenses and at least one spacing piece, where the seven lenses and the at least one spacing piece are disposed in the lens barrel, and the seven lenses sequentially comprise a first lens, a second lens, a third lens, a fourth lens, a fifth lens, a sixth lens and a seventh lens from an object side to an image side; the at least one spacing piece includes a first spacing piece, the first spacing piece is positioned between the first lens and the second lens and is in partial contact with an image-side surface of the first lens; where half of a maximal field-of-view Semi-FOV of the optical camera lens assembly and a maximal height L of the lens barrel satisfy: 0.5<TAN (Semi-FOV)/L<0.8; and a spacing distance EP01 between an object-side end surface of the lens barrel and the first spacing piece, an outer diameter D1s of an object-side surface of the first spacing piece, an effective focal length f1 of the first lens, and a maximal effective radius DT12 of the image-side surface of the first lens satisfy: −2.5<EP01*D1s/(f1*DT12)<−1.0.

An aspect of the present disclosure provides an optical camera lens assembly. The optical camera lens assembly includes a lens barrel, seven lenses and at least one spacing piece, where the seven lenses and the at least one spacing piece are disposed in the lens barrel, and the seven lenses sequentially comprise a first lens, a second lens, a third lens, a fourth lens, a fifth lens, a sixth lens and a seventh lens from an object side to an image side; the at least one spacing piece includes a first spacing piece, the first spacing piece is positioned between the first lens and the second lens and is in partial contact with an image-side surface of the first lens; where half of a maximal field-of-view Semi-FOV of the optical camera lens assembly and a maximal height L of the lens barrel satisfy: 0.5<TAN(Semi-FOV)/L<0.8; and the effective focal length f1 of the first lens, a refractive index N1 of the first lens, and an inner diameter d1s of the object-side surface of the first spacing piece satisfy: −1.5<f1*N1/d1s<−1.2.

Furthermore, the first lens has a negative refractive power, an object-side surface of the first lens is a concave surface, and the image-side surface of the first lens is a concave surface; the second lens has a positive refractive power, and an object-side surface of the second lens is a convex surface; the third lens has a positive refractive power, an object-side surface of the third lens is a convex surface, and an image-side surface of the third lens is a convex surface; the fourth lens has a negative refractive power, an object-side surface of the fourth lens is a convex surface, and an image-side surface of the fourth lens is a concave surface; the fifth lens has a positive refractive power, and an object-side surface of the fifth lens is a convex surface; the sixth lens has a positive refractive power, an object-side surface of the sixth lens is a convex surface, and an image-side surface of the sixth lens is a convex surface; and the seventh lens has a negative refractive power, an object-side surface of the seventh lens is a convex surface, and an image-side surface of the seventh lens is a concave surface.

Furthermore, the effective focal length f1 of the first lens, a refractive index N1 of the first lens, and an inner diameter d1s of the object-side surface of the first spacing piece satisfy: −1.5<f1*N1/d1s<−1.2.

Furthermore, the at least one spacing piece further comprises a second spacing piece, the second spacing piece is positioned between the second lens and the third lens and is in partial contact with an image-side surface of the second lens, and a spacing distance EP12 between the first spacing piece and the second spacing piece, a center thickness CT2 of the second lens on an optical axis, the spacing distance EP01 between the object-side end surface of the lens barrel and the first spacing piece, and a center thickness CT1 of the first lens on the optical axis satisfy: 1.5<(EP12+CT2)/(EP01+CT1)<2.2.

Furthermore, a radius of curvature R1 of an object-side surface of the first lens, a radius of curvature R3 of an object-side surface of the second lens, a maximal effective radius DT11 of the object-side surface of the first lens, and an inner diameter d1s of the object-side surface of first spacing piece satisfy: −1.0<R1/R3+DT11/d1s<−0.2.

Furthermore, the at least one spacing piece further comprises a second spacing piece, the second spacing piece is positioned between the second lens and the third lens and is in partial contact with an image-side surface of the second lens, and a combined focal length f23 of the second lens and the third lens, and an inner diameter d2s of an object-side surface of the second spacing piece satisfy: 1.0<f23/d2s<1.3.

Furthermore, the at least one spacing piece further comprises a second spacing piece and a third spacing piece, the second spacing piece is positioned between the second lens and the third lens and is in partial contact with an image-side surface of the second lens, and the third spacing piece is positioned between the third lens and the fourth lens and is in partial contact with an image-side surface of the third lens, wherein an axial distance SAG32 from an intersection point of the image-side surface of the third lens and an optical axis to a projection point of an effective radius vertex of the image-side surface of the third lens onto the optical axis, and a spacing distance EP23 between the second spacing piece and the third spacing piece satisfy: −0.5<SAG32/EP23<−0.3.

Furthermore, the at least one spacing piece further comprises a third spacing piece and a fourth spacing piece, the third spacing piece is positioned between the third lens and the fourth lens and is in partial contact with an image-side surface of the third lens, and the fourth spacing piece is positioned between the fourth lens and the fifth lens and is in partial contact with an image-side surface of the fourth lens, wherein an axial distance SAG42 from an intersection point of the image-side surface of the fourth lens and an optical axis to a projection point of an effective radius vertex of the image-side surface of the fourth lens onto the optical axis, and a spacing distance EP34 between the third spacing piece and the fourth spacing piece satisfy: 0.1<SAG42/EP34<0.3.

Furthermore, the at least one spacing piece further comprises a third spacing piece and a fourth spacing piece, the third spacing piece is positioned between the third lens and the fourth lens and is in partial contact with an image-side surface of the third lens, and the fourth spacing piece is positioned between the fourth lens and the fifth lens and is in partial contact with an image-side surface of the fourth lens, wherein an outer diameter D3m of an image-side surface of the third spacing piece, an outer diameter D4m of an image-side surface of the fourth spacing piece, a maximal effective radius DT41 of an object-side surface of the fourth lens, and a maximal effective radius DT51 of an object-side surface of the fifth lens satisfy: 0.3<(D4m−D3m)/(DT51−DT41)≤6.20.

Furthermore, the at least one spacing piece further comprises a fourth spacing piece and a fifth spacing piece, the fourth spacing piece is positioned between the fourth lens and the fifth lens and is in partial contact with an image-side surface of the fourth lens, and the fifth spacing piece is positioned between the fifth lens and the sixth lens and is in partial contact with an image-side surface of the fifth lens, wherein a maximal thickness CP4 of the fourth spacing piece, a maximal thickness CP5 of the fifth spacing piece, a spacing distance EP45 between the fourth spacing piece and the fifth spacing piece, an effective focal length f4 of the fourth lens, and a refractive index N4 of the fourth lens satisfy: −0.15<(CP4+EP45+CP5)/(f4*N4)<−0.05.

Furthermore, the at least one spacing piece further comprises a fifth spacing piece and a fifth spacing piece, the fifth spacing piece is positioned between the fifth lens and the sixth lens and is in partial contact with an image-side surface of the fifth lens, and the sixth spacing piece is positioned between the sixth lens and the seventh lens and is partially against an image-side surface of the sixth lens, wherein a spacing distance EP56 between the fifth spacing piece and the sixth spacing piece, a radius of curvature R12 of the image-side side surface of the sixth lens, and a refractive index N6 of the sixth lens satisfy: −0.5<EP56/(R12*N6)<−0.3.

Furthermore, the at least one spacing piece further comprises a fifth spacing piece, the fifth spacing piece is positioned between the fifth lens and the sixth lens and is in partial contact with an image-side surface of the fifth lens, wherein an inner diameter d5s of an object-side surface of the fifth spacing piece and a combined focal length f56 of the fifth lens and the sixth lens satisfy: 1.3<d5s/f56<1.6.

Furthermore, the at least one spacing piece further comprises a sixth spacing piece, the sixth spacing piece is positioned between the sixth lens and the seventh lens and is in partial contact with an image-side surface of the sixth lens, wherein an effective focal length f7 of the seventh lens, a refractive index N7 of the seventh lens, and an inner diameter d6s of an object-side surface of the sixth spacing piece satisfy: −1.3<f7*N7/d6s<−0.8.

According to the technology solution of the present disclosure, the optical camera lens assembly includes a lens barrel, seven lenses and at least one spacing piece, where the seven lenses and the at least one spacing piece are disposed in the lens barrel, and the seven lenses sequentially comprise a first lens, a second lens, a third lens, a fourth lens, a fifth lens, a sixth lens and a seventh lens from an object side to an image side; the at least one spacing piece includes a first spacing piece, the first spacing piece is positioned between the first lens and the second lens and is in partial contact with an image-side surface of the first lens; where half of a maximal field-of-view Semi-FOV of the optical camera lens assembly and a maximal height L of the lens barrel satisfy: 0.5<TAN (Semi-FOV)/L<0.8; and a spacing distance EP01 between an object-side end surface of the lens barrel and the first spacing piece, an outer diameter D1s of an object-side surface of the first spacing piece, an effective focal length f1 of the first lens, and a maximal effective radius DT12 of the image-side surface of the first lens satisfy: −2.5<EP01*D1s/(f1*DT12)<−1.0.

The optical camera lens assembly of the present disclosure is composed of the lens barrel and the seven lenses and the at least one spacing piece that are disposed in the lens barrel. By reasonably arranging the seven lenses and the at least one spacing piece, and when the optical camera lens assembly satisfies 0.5<TAN(Semi-FOV)/L<0.8, the ultra-wide-angle property of the optical camera lens assembly can be ensured by controlling the maximal field-of-view, which ensures the amount of incident light. Moreover, by controlling the maximal height of the lens barrel, the overall size is ensured, which ensures the miniaturization of the optical camera lens assembly. However, when the ultra-wide-angle and miniaturization are satisfied, the problem of serious stray light is easy to occur, particularly, the first lens will affect the overall imaging quality. Therefore, in embodiments of the present disclosure, within the constraint of −2.5<EP01*D1s/(f1*DT12)<−1.0, it is ensured that the thin-to-thickness ratio of the first lens is within a reasonable range by controlling the spacing between the object-side end surface of the lens barrel and the first spacing piece. The excess light can be effectively blocked by controlling the outer diameter of the object-side surface of the first spacing piece, thereby reducing the generation of stray light. The structure of the first lens can be controlled by controlling the effective focal length of the first lens and the maximal effective radius of the image-side surface of the first lens, to control the incident light and regulate the optical path at the same time, thereby effectively improving the imaging quality of the optical camera lens assembly.

### BRIEF DESCRIPTION OF THE DRAWINGS

The accompanying drawings of the specification that constitute a portion of the present disclosure are used to provide a further understanding of the present disclosure. The schematic embodiments of the present disclosure and the descriptions thereof are used to explain the present disclosure and do not constitute an improper limitation to the present disclosure.

FIG. 1 is a dimensioning diagram of an optical camera lens assembly of an alternative embodiment of the present disclosure;

FIG. 2 is a schematic structural diagram of an optical camera lens assembly in a first state of Embodiment 1 of the present disclosure;

FIG. 3 is a schematic structural diagram of the optical camera lens assembly in a second state of Embodiment 1 of the present disclosure;

FIGS. 4-6 respectively illustrate a longitudinal aberration curve, an astigmatic curve and a lateral color curve of the optical camera lens assembly of Embodiment 1 of the present disclosure;

FIG. 7 is a schematic structural diagram of an optical camera lens assembly in a first state of Embodiment 2 of the present disclosure;

FIG. 8 is a schematic structural diagram of the optical camera lens assembly in a second state of Embodiment 2 of the present disclosure;

FIGS. 9-11 respectively illustrate a longitudinal aberration curve, an astigmatic curve and a lateral color curve of the optical camera lens assembly of Embodiment 2 of the present disclosure;

FIG. 12 is a schematic structural diagram of an optical camera lens assembly in a first state of Embodiment 3 of the present disclosure;

FIG. 13 is a schematic structural diagram of the optical camera lens assembly in a second state of Embodiment 3 of the present disclosure;

FIGS. 14-16 respectively illustrate a longitudinal aberration curve, an astigmatic curve and a lateral color curve of the optical camera lens assembly of Embodiment 3 of the present disclosure;

FIGS. 17 and 18 respectively illustrate a stray light diagram and a light path diagram of an optical camera lens assembly of an alternative embodiment of the present disclosure, when the optical camera lens assembly satisfies TAN(Semi-FOV)/L=0.7 and EP01*D1s/(f1*DT12)=−1.2;

FIGS. 19 and 20 respectively illustrate a stray light diagram and a light path diagram of an optical camera lens assembly of an alternative embodiment of the present disclosure, when the optical camera lens assembly satisfies 0.5<TAN(Semi-FOV)/L=0.7 and EP01*D1s/(f1*DT12)=−2.2;

FIGS. 21 and 22 respectively illustrate a stray light diagram and a light path diagram of an optical camera lens assembly of an alternative embodiment of the present disclosure, when the optical camera lens assembly satisfies TAN(Semi-FOV)/L=0.4 and EP01*D1s/(f1*DT12)=−3.0;

FIGS. 23 and 24 respectively illustrate a stray light diagram and a light path diagram of an optical camera lens assembly of an alternative embodiment of the present disclosure, when the optical camera lens assembly satisfies 0.5<TAN(Semi-FOV)/L=0.95 and EP01*D1s/(f1*DT12)=1; and

FIG. 25 is an other dimensioning diagram of an optical camera lens assembly of an alternative embodiment of the present disclosure.

Here, the above drawings include the following reference numerals:
P0: lens barrel; E1: first lens; S1: object-side surface of the first lens; S2: image-side surface of the first lens; E2: second lens; S3: object-side surface of the second lens; S4: image-side surface of the second lens; E3: third lens; S5: object-side surface of the third lens; S6: image-side surface of the third lens; E4: fourth lens; S7: object-side surface of the fourth lens; S8: image-side surface of the fourth lens; E5: fifth lens; S9: object-side surface of the fifth lens; S10: image-side surface of the fifth lens; E6: sixth lens; S11: object-side surface of the sixth lens; S12: image-side surface of the sixth lens; E7: seventh lens; S13: object-side surface of the seventh lens; S14: image-side surface of the seventh lens; P1: first spacing piece; P2: second spacing piece; P3: third spacing piece; P4: fourth spacing piece; P5: fifth spacing piece; and P6: sixth spacing piece.

### DETAILED DESCRIPTION OF EMBODIMENTS

It should be noted that embodiments in the present disclosure and the features in the embodiments may be combined with each other on a non-conflict basis. Embodiments of the present disclosure will be described below in detail with reference to the accompanying drawings.

It should be noted that, unless otherwise specified, all technical and scientific terms used in the present disclosure have the same meaning as commonly understood by those of ordinary skill in the art to which the present disclosure belongs.

In the present disclosure, unless stated otherwise, the used orientation words such as “upper, lower, top and bottom” are generally for the directions shown in the accompanying drawings, or for the parts themselves in a vertical, perpendicular or gravitational direction. Similarly, for the convenience of understanding and description, “inner and outer” refer to being inner and outer relative to the contours of the parts themselves. However, the above orientation words are not used to limit the present disclosure.

It should be noted that, in the specification, the expressions such as “first,” “second” and “third” are only used to distinguish one feature from another, rather than represent any limitations to the features. Thus, the first lens discussed below may also be referred to as the second lens or the third lens without departing from the teachings of the present disclosure.

In the accompanying drawings, the thicknesses, sizes and shapes of the lenses are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near an optical axis. If a lens surface is a convex surface and the position of the convex surface is not defined, it represents that the lens surface is a convex surface at least at the paraxial area. If the lens surface is a concave surface and the position of the concave surface is not defined, it represents that the lens surface is a concave surface at least at the paraxial area. The determination for the surface shape at the paraxial area may be according to the determination approach of those of ordinary skill in the art, in which whether the surface is concave or convex is determined according to whether the R value (R refers to a radius of curvature at the paraxial area, and the R value usually refers to the R value on a lens database (lens data) in optical software) is positive or negative. For a surface through which the light enters the lens, it is determined that the surface is a convex surface when the R value is positive, and it is determined that the surface is a concave surface when the R value is negative. For a surface through which the light emits the lens, it is determined that the surface is a concave surface when the R value is positive, and it is determined that the surface is a convex surface when the R value is negative.

In order to solve the problem of the optical camera lens assembly in the prior art that the stray light is serious when the optical camera lens assembly satisfies an ultra-wide angle and miniaturization, embodiments of the present disclosure provide an optical camera lens assembly.

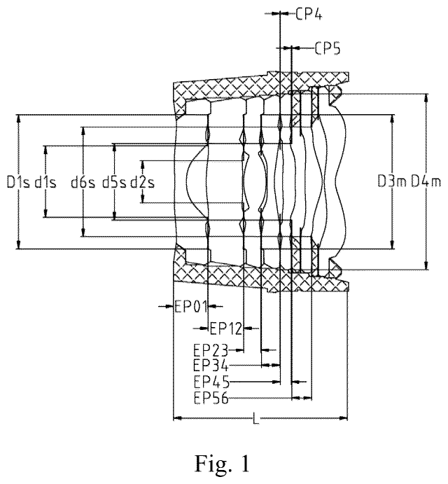

As shown in FIGS. 1-25, in an alternative implementation of the present disclosure, an optical camera lens assembly includes a lens barrel, seven lenses and at least one spacing piece. The seven lenses and the at least one spacing piece are disposed in the lens barrel. The seven lenses sequentially include a first lens, a second lens, a third lens, a fourth lens, a fifth lens, a sixth lens and a seventh lens from an object-side to an image-side. The at least one spacing piece includes a first spacing piece that is positioned between the first lens and the second lens and is in partial contact with an image-side surface of the first lens. Half of a maximal field-of-view Semi-FOV of the optical camera lens assembly and a maximal height L of the lens barrel satisfy: 0.5<TAN(Semi-FOV)/L<0.8. A spacing EP01 between an object-side end surface of the lens barrel and the first spacing piece, an outer diameter D1s of an object-side surface of the first spacing piece, an effective focal length f1 of the first lens, and a maximal effective radius DT12 of the image-side surface of the first lens satisfy: −2.5<EP01*D1s/(f1*DT12)<−1.0.

The optical camera lens assembly of the present disclosure is composed of the lens barrel and the seven lenses and the at least one spacing piece that are disposed in the lens barrel. By reasonably arranging the seven lenses and the at least one spacing piece, and when the optical camera lens assembly satisfies 0.5<TAN(Semi-FOV)/L<0.8, the ultra-wide-angle property of the optical camera lens assembly can be ensured by controlling the maximal field-of-view, which ensures the amount of incident light. Moreover, by controlling the maximal height of the lens barrel, the overall size is ensured, which ensures the miniaturization of the optical camera lens assembly. However, when the ultra-wide-angle and miniaturization are satisfied, the problem of serious stray light is easy to occur, particularly, the first lens will affect the overall imaging quality. Therefore, in embodiments of the present disclosure, within the constraint of −2.5<EP01*D1s/(f1*DT12)<−1.0, it is ensured that the thin-to-thickness ratio of the first lens is within a reasonable range by controlling the spacing between the object-side end surface of the lens barrel and the first spacing piece. The excess light can be effectively blocked by controlling the outer diameter of the object-side surface of the first spacing piece, thereby reducing the generation of stray light. The structure of the first lens can be controlled by controlling the effective focal length of the first lens and the maximal effective radius of the image-side surface of the first lens, to control the incident light and regulate the optical path at the same time, thereby effectively improving the imaging quality of the optical camera lens assembly.

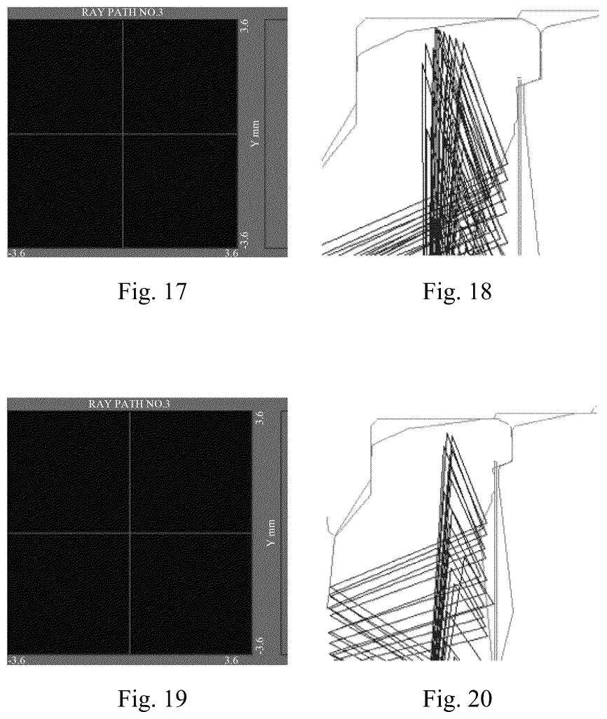

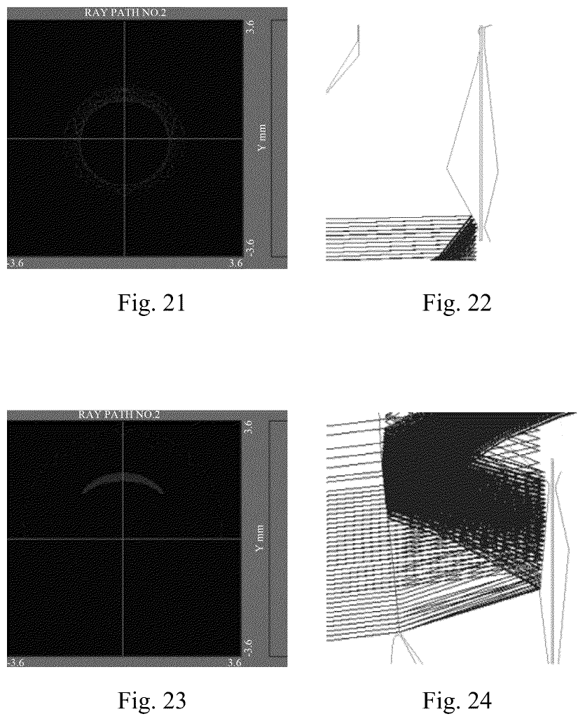

In addition, as shown in FIGS. 17-24 and Table 1-1. FIGS. 17 and 18 respectively illustrate a stray light diagram and a light path diagram of an optical camera lens assembly of Sample 1 that satisfies TAN(Semi-FOV)/L=0.7 and EP01*D1s/(f1*DT12)=−1.2. FIGS. 19 and 20 respectively illustrate a stray light diagram and a light path diagram of an optical camera lens assembly of Sample 2 that satisfies TAN(Semi-FOV)/L=0.7 and EP01*D1s/(f1*DT12)=−2.2. FIGS. 21 and 22 respectively illustrate a stray light diagram and a light path diagram of an optical camera lens assembly of Sample 3 that satisfies TAN(Semi-FOV)/L=0.4 and EP01*D1s/(f1*DT12)=−3.0. FIGS. 23 and 24 respectively illustrate a stray light diagram and a light path diagram of an optical camera lens assembly of Sample 4 that satisfies TAN(Semi-FOV)/L=0.95 and EP01*D1s/(f1*DT12)=1.

Through a comparative analysis, in Samples 1 and 2, the energy standard levels of the stray light spots shown in FIGS. 17 and 19 are both 5E−7, the angles are both 6 degrees, the stray light energy is low, and the requirements for improving stray light are met. Moreover, according to the light paths shown in FIGS. 18 and 20, it can be seen that the main light paths are scattered and are accordingly presented as a contour outlined with spots in the corresponding light spot diagrams. In Samples 3 and 4, as compared with FIGS. 18 and 20, the light paths FIGS. 22 and 24 are more densely, and accordingly, the corresponding light spots in the light spot diagrams are more concentrated and apparent, and the stray light is more apparent, which cannot meet the requirements for low stray light. Further, according to the data in Table 1-1, the strongest energy of the light spot in Sample 1 is 1.43E−6, the strongest energy of the light spot in Sample 2 is 1.82E−6, the strongest energy of the light spot in Sample 3 is 7.2E−7, and the strongest energy of the light spot in Sample 4 is 5.6E−7. It can be seen that the strongest energy of the light spots in Samples 1 and 2 is significantly smaller than that of the light spots in Samples 3 and 4. Accordingly, the stray light improvement effects of Samples 1 and 2 are better than those of Samples 3 and 4. Therefore, in embodiments of the present disclosure, with the constraints of 0.5<TAN(Semi-FOV)/L<0.8 and −2.5<EP01*D1s/(f1*DT12)<−1.0, the ultra-wide angle and miniaturization characteristics can be ensured, and at the same time, the spacing pieces can effectively block the excess light to reduce the generation of stray light, thereby greatly improving the stray light improvement effect.

TABLE 1-1
Stray light analysis table

| | Sample 1 | Sample 2 | Sample 3 | Sample 4 |
|---|---|---|---|---|
| | TAN(Semi- | TAN(Semi- | TAN(Semi- | TAN(Semi- |
| | FOV)/L = 0.7 | FOV)/L = 0.7 | FOV)/L = 0.4 | FOV)/L = 0.95 |
| Scheme | EP01*D1s/(f1*DT12) = −1.2 | EP01*D1s/(f1*DT12) = −2.2 | EP01*D1s/(f1*DT12) = −3.0 | EP01*D1s/(f1*DT12) = 1 |
| Strongest | 1.43E⁻⁶ | 1.82E⁻⁶ | 7.2E⁻⁷ | 5.6E⁻⁷ |
| light spot | | | | |
| energy | | | | |
| Illustration | FIGS. 17 and 18 | FIGS. 19 and 20 | FIGS. 21 and 22 | FIGS. 23 and 24 |
| State | OK | OK | NG | NG |

In this implementation, the first lens has a negative refractive power, an object-side surface of the first lens is a concave surface, and the image-side surface of the first lens is a concave surface. The second lens has a positive refractive power, and an object-side surface of the second lens is a convex surface. The third lens has a positive refractive power, an object-side surface of the third lens is a convex surface, and an image-side surface of the third lens is a convex surface. The fourth lens has a negative refractive power, an object-side surface of the fourth lens is a convex surface, and an image-side surface of the fourth lens is a concave surface. The fifth lens has a positive refractive power, and an object-side surface of the fifth lens is a convex surface. The sixth lens has a positive refractive power, an object-side surface of the sixth lens is a convex surface, and an image-side surface of the sixth lens is a convex surface. The seventh lens has a negative refractive power, an object-side surface of the seventh lens is a convex surface, and an image-side surface of the seventh lens is a concave surface. The optical camera lens assembly is composed of seven plastic aspheric lenses. The refractive power refers to the capability of the optical system to deflect light. The first lens has a light diverging effect, the second lens has a light converging effect, the third lens has a light converging effect, the fourth lens has a light diverging effect, the fifth lens has a light converging effect, the sixth lens has a light converging effect, and the seventh lens has a light diverging effect. This combination can help the combined optical components to become ideal optical components under ideal conditions.

In this implementation, the effective focal length f1 of the first lens, a refractive index N1 of the first lens, and an inner diameter d1s of the object-side surface of the first spacing piece satisfy: −1.5<f1*N1/d1s<−1.2. With the constraint of this conditional expression, it helps to control the range of distortion within a reasonable range by controlling the effective focal length and refractive index of the first lens, and the incident light can be controlled by reasonably controlling the inner diameter of the object-side surface of the first spacing piece, thereby effectively reducing the stray light phenomenon of the first lens.

In this implementation, the at least one spacing piece further includes a second spacing piece that is positioned between the second lens and the third lens and is in partial contact with an image-side surface of the second lens. A spacing distance EP12 between the first spacing piece and the second spacing piece, a center thickness CT2 of the second lens on an optical axis, the spacing distance EP01 between the object-side end surface of the lens barrel and the first spacing piece, and a center thickness CT1 of the first lens on the optical axis satisfy: 1.5<(EP12+CT2)/(EP01+CT1)<2.2. The constraint of this conditional expression is conducive to the practicability of lens molding and ensures that the thin-to-thickness ratios of the first lens and the second lens are within a reasonable range.

In this implementation, a radius of curvature R1 of the object-side surface of the first lens, a radius of curvature R3 of the object-side surface of the second lens, a maximal effective radius DT11 of the object-side surface of the first lens, and the inner diameter d1s of the object-side surface of first spacing piece satisfy: −1.0<R1/R3+DT11/d1s<−0.2. With the constraint of this conditional expression, the direction of the light is determined to a certain extent by controlling the radii of curvature of the image-side surfaces of the first lens and the second lens. Moreover, the control for the maximal effective radius of the object-side surface of the first lens and the inner diameter d1s of the object-side surface of first spacing piece is conducive to controlling the incident light, thereby effectively avoiding stray light.

In this implementation, a combined focal length f23 of the second lens and the third lens and an inner diameter d2s of an object-side surface of the second spacing piece satisfy: 1.0<f23/d2s<1.3. With the constraint of this conditional expression, it helps to control the range of distortion within a reasonable range. Moreover, by controlling the inner diameter of the object-side surface of the second spacing piece, the efficiency of blocking stray light determined, the direction of the light can be effectively controlled, thereby improving the final imaging effect.

In this implementation, the at least one spacing piece further includes a third spacing piece that is positioned between the third lens and the fourth lens and is in partial contact with the image-side surface of the third lens. An axial distance SAG32 from an intersection point of the image-side surface of the third lens and the optical axis to a projection point of an effective radius vertex of the image-side surface of the third lens onto the optical axis, and a spacing distance EP23 between the second spacing piece and the third spacing piece satisfy: −0.5<SAG32/EP23<−0.3. With the constraint of this conditional expression, by controlling the ratio of the axial distance from the intersection point of the image-side surface of the third lens and the optical axis to the effective radius vertex of the image-side surface of the third lens to the spacing between the second spacing piece and the third spacing piece, it may effectively control the paths of the incident light and the emergent light and adjust the optical system of the optical camera lens assembly.

In this implementation, the at least one spacing piece further includes a fourth spacing piece that is positioned between the fourth lens and the fifth lens and is in partial contact with the image-side surface of the fourth lens. An axial distance SAG42 from an intersection point of the image-side surface of the fourth lens and the optical axis to a projection point of an effective radius vertex of the image-side surface of the fourth lens onto the optical axis, and a spacing distance EP34 between the third spacing piece and the fourth spacing piece satisfy: 0.1<SAG42/EP34<0.3. With the constraint of this conditional expression, by controlling the ratio of the axial distance from the intersection point of the image-side surface of the fourth lens and the optical axis to the effective radius vertex of the image-side surface of the fourth lens to the spacing between the third spacing piece and the fourth spacing piece, it may effectively control the paths of the incident light and the emergent light and adjust the optical system of the optical camera lens assembly.

It should be noted here that an axial distance SAG may be a positive value or a negative value, and the signs “positive” and “negative” herein denotes the direction of the axial distance SAG. and the has a direction, and an axial distance SAG. An axial distance SAG from the object side to the image side is a positive value, and the axial distance SAG from the image side to the object side is a negative value.

In this implementation, an outer diameter D3m of an image-side surface of the third spacing piece, an outer diameter D4m of an image-side surface of the fourth spacing piece, a maximal effective radius DT41 of the object-side surface of the fourth lens, and a maximal effective radius DT51 of the object-side surface of the fifth lens satisfy: 0.3<(D4m−D3m)/(DT51−DT41)≤6.2. With the constraint of this conditional expression, by controlling the outer diameter of the image-side surface of the fourth spacing piece and the outer diameter of the image-side surface of the third spacing piece, it can be ensured that the spacing pieces are capable of, while blocking light, controlling the maximal effective radius of the object-side surface of the fourth lens and the maximal effective radius of the object-side surface of the fifth lens, to indirectly control the inner diameter of the lens barrel, thereby improving the uniformity of the wall thickness of the lens barrel

In this implementation, the at least one spacing piece further includes a fifth spacing piece that is positioned between the fifth lens and the sixth lens and is in partial contact with an image-side surface of the fifth lens. A maximal thickness CP4 of the fourth spacing piece, a maximal thickness CP5 of the fifth spacing piece, a spacing distance EP45 between the fourth spacing piece and the fifth spacing piece, an effective focal length f4 of the fourth lens, and a refractive index N4 of the fourth lens satisfy: −0.15<(CP4+EP45+CP5)/(f4*N4)<−0.05. With the constraint of this conditional expression, by the controlling for the maximal thickness of the fourth spacing piece, the spacing between the fourth spacing piece and the fifth spacing piece, and the maximal thickness of the fifth spacing piece, it is conducive to the molding of the lenses. Moreover, the range of distortion can be controlled within a reasonable range by controlling the effective focal length and refractive index of the fourth lens.

In this implementation, the at least one spacing piece further includes a sixth spacing piece that is positioned between the sixth lens and the seventh lens and is partially against the image-side surface of the sixth lens. A spacing distance EP56 between the fifth spacing piece and the sixth spacing piece, a radius of curvature R12 of the image-side surface of the sixth lens, and a refractive index N6 of the sixth lens satisfy: −0.5<EP56/(R12*N6)<−0.3. The structure of the sixth lens can be optimized by controlling the spacing between the fifth spacing piece and the sixth spacing piece. The range of distortion can be further optimized by controlling the radius of curvature of the image-side surface of the sixth lens and the refractive index of the sixth lens.

In this implementation, an inner diameter d5s of an object-side surface of the fifth spacing piece and a combined focal length f56 of the fifth lens and the sixth lens satisfy: 1.3<d5s/f56<1.6. With the constraint of this conditional expression, the moldability of the sixth lens can be optimized by controlling the ratio of the inner diameter of the object-side surface of the fifth spacing piece to the combined focal length of the fifth lens and the sixth lens.

In this implementation, an effective focal length f7 of the seventh lens, a refractive index N7 of the seventh lens, and an inner diameter d6s of an object-side surface of the sixth spacing piece satisfy: −1.3<f7*N7/d6s<−0.8. With the constraint of this conditional expression, the range of distortion can be further optimized by controlling the effective focal length and refractive index of the seventh lens, and the stray light can be effectively blocked by controlling the inner diameter of the object-side surface of the sixth spacing piece.

In addition, in an other alternative implementation of the present disclosure, an optical camera lens assembly is further provided. The optical camera lens assembly includes a lens barrel, seven lenses and at least one spacing piece. The seven lenses and the at least one spacing piece are disposed in the lens barrel. The seven lenses sequentially include a first lens, a second lens, a third lens, a fourth lens, a fifth lens, a sixth lens and a seventh lens from an object side to an image side. The at least one spacing piece includes a first spacing piece that is positioned between the first lens and the second lens and is in partial contact with an image-side surface of the first lens. Half of a maximal field-of-view Semi-FOV of the optical camera lens assembly and a maximal height L of the lens barrel satisfy: 0.5<TAN(Semi-FOV)/L<0.8. An effective focal length f1 of the first lens, a refractive index N1 of the first lens, and an inner diameter d1s of an object-side surface of the first spacing piece satisfy: −1.5<f1*N1/d1s<−1.2.

The optical camera lens assembly of the present disclosure is composed of a lens barrel and seven lenses and at least one spacing piece that are disposed in the lens barrel. Under the premise of satisfying 0.5<TAN(Semi-FOV)/L<0.8, the ultra-wide-angle property of the optical camera lens assembly can be ensured, which ensures the amount of incident light. Moreover, by controlling the maximal height of the lens barrel, the overall size is ensured, which ensures the miniaturization of the optical camera lens assembly. However, when the ultra-wide-angle and miniaturization are satisfied, problems of serious stray light and large distortion are easy to occur. Therefore, in embodiments of the present disclosure, with the constraint of −1.5<f1*N1/d1s<−1.2, it helps to enable the optical camera lens assembly to control, while satisfying the ultra-wide-angle property and ensuring the miniaturization of the lens assembly, the range of distortion within a reasonable range by controlling the effective focal length and refractive index of the first lens. Moreover, it helps to enable the optical camera lens assembly to control, while satisfying the ultra-wide-angle property and ensuring the miniaturization of the lens assembly, the incident light by controlling the inner diameter of the object-side surface of the first spacing piece, which effectively reduce the stray light phenomenon of the first lens.

Alternatively, the above optical camera lens assembly may further include a protective glass for protecting a photosensitive element on an image plane.

The optical camera lens assembly in embodiments of the present disclosure may use a plurality of lenses, for example, the seven lenses described above. In embodiments of the present disclosure, at least one of the surfaces of the lenses is an aspheric surface. An aspheric lens is characterized in that the curvature continuously changes from the center of the lens to the periphery of the lens. Different from a spherical lens having a constant curvature from the center of the lens to the periphery of the lens, the aspheric lens has a better radius-of-curvature characteristic, and has advantages of improving the distortion aberration and improving the astigmatic aberration. The use of the aspheric lens can eliminate as much as possible the aberrations that occur during the imaging, thereby improving the imaging quality.

However, it should be understood by those skilled in the art that the various results and advantages described herein may be obtained by changing the number of the lenses constituting the optical camera lens assembly without departing from the technical solution claimed by the present disclosure. For example, although an example in which the optical camera assembly lenses the lens includes seven is described in implementations/embodiments, the optical camera lens assembly is not limited to including seven lenses. If desired, the optical camera lens assembly may alternatively include other numbers of lenses.

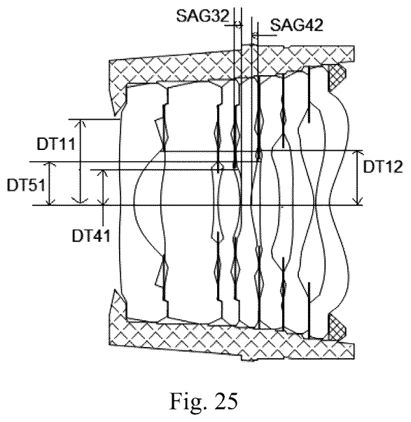

FIGS. 1 and 25 are schematic structural diagrams of an optical camera lens assembly of the present disclosure. Here, parameters such as D1s, d1s, d6s, d5s, d2s, D3m, D4m, CP4, CP5, L, EP01, EP12, EP23, EP34, EP45, EP56, DT12, DT11, DT41, DT51, SAG32 and SAG42 are marked in FIG. 1, for clear and intuitive understanding of the significance of the parameters. In order to facilitate showing the optical camera lens assembly and a specific surface type, these parameters will not be embodied in the following descriptions of the detailed embodiments.

Examples of specific surface types and parameters of the optical camera lens assembly that may be applicable to the above implementations are further described below with reference to the accompanying drawings.

It should be noted that the optical camera lens assembly has a first state and a second state in the following embodiments. For the optical camera lens assemblies in the first state and the second state in the same embodiment, the parameters such as the radii of curvature and center thicknesses of the first to seventh lenses, the spacing distances between the lenses and the high-order coefficients of the lenses are the identical in the first and second states, but the parameters such as the thicknesses and the inner and outer diameters of the lens barrel and the first to sixth spacing pieces and the shapes of some lenses are different in the first and second states. In other words, the main structures for imaging are the same, but the auxiliary structures for imaging are different.

It should be noted that any one of the following Embodiments 1-3 is applicable to all embodiments of the present disclosure.

Clearly, this implementation may further include the other conditional expressions in the above implementation, and the conditional expressions will not be repeatedly described one by one here.

### Embodiment 1

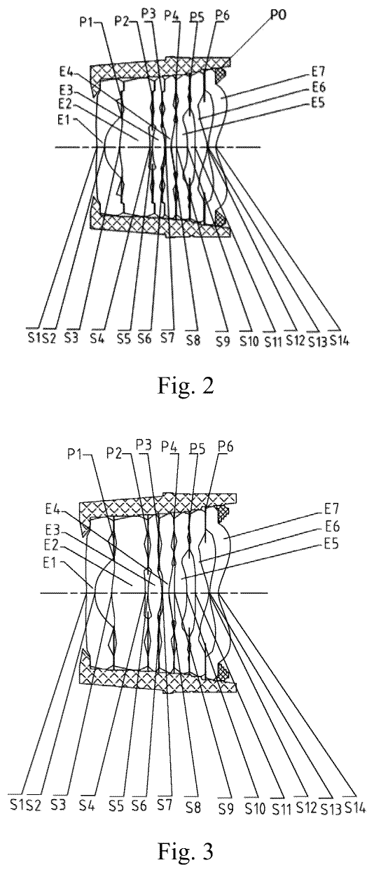

As shown in FIGS. 2-6, an optical camera lens assembly of Embodiment 1 is described. FIG. 2 is a schematic structural diagram of the optical camera lens assembly in a first state of Embodiment 1, and FIG. 3 is a schematic structural diagram of the optical camera lens assembly in a second state of Embodiment 1.

As shown in FIGS. 2 and 3, the optical camera lens assembly includes a lens barrel P0, and a first lens E1, a first spacing piece P1, a second lens E2, a second spacing piece P2, a third lens E3, a third spacing piece P3, a fourth lens E4, a fourth spacing piece P4, a fifth lens E5, a fifth spacing piece P5, a sixth lens E6, a sixth spacing piece P6 and a seventh lens E7, that are sequentially disposed in the lens barrel P0 along an optical axis of the lens barrel P0 from an object side to an image side.

As shown in FIG. 2, in the optical camera lens assembly in the first state, an object-side surface S1 of the first lens is partially against the lens barrel P0. An object-side surface and image-side surface of the first spacing piece P1 are partially against an image-side surface S2 of the first lens and an object-side surface S3 of the second lens, respectively. An object-side surface and image-side surface of the second spacing piece P2 are partially against an image-side surface S4 of the second lens and an object-side surface S5 of the third lens, respectively. An object-side surface and image-side surface of the third spacing piece P3 are partially against an image-side surface S6 of the third lens and an object-side surface S7 of the fourth lens, respectively. An object-side surface and image-side surface of the fourth spacing piece P4 are partially against an image-side surface S8 of the fourth lens and an object-side surface S9 of the fifth lens, respectively. An object-side surface and image-side surface of the fifth spacing piece P5 are partially against an image-side surface S10 of the fifth lens and an object-side surface S11 of the sixth lens, respectively. An object-side surface and image-side surface of the sixth spacing piece P6 are partially against an image-side surface S12 of the sixth lens and an object-side surface S13 of the seventh lens, respectively.

As shown in FIG. 3, the support approach of the spacing pieces in the optical camera lens assembly in the second state is the same as that in the first state. Accordingly, for the support approach, reference may be made to the related description of the optical camera lens assembly in the first state, and thus the support approach will not be repeatedly described here.

In summary, the structure parameters of the optical camera lens assembly of Embodiment 1 in the first state 1-1 and the second state 1-2 are shown in Table 1. (Unit: mm)

TABLE 1

state

| parameter | 1-1 | 1-2 |
|---|---|---|
| d1s (mm) | 2.934 | 2.934 |
| D1s (mm) | 5.478 | 6.820 |
| d2s (mm) | 1.673 | 1.673 |
| D3m (mm) | 5.427 | 7.020 |
| D4m (mm) | 7.120 | 7.120 |
| d5s (mm) | 3.086 | 3.086 |
| d6s (mm) | 4.490 | 4.490 |
| CP4 (mm) | 0.018 | 0.018 |
| CP5 (mm) | 0.018 | 0.018 |
| EP01 (mm) | 1.537 | 1.056 |
| EP12 (mm) | 1.517 | 1.517 |
| EP23 (mm) | 0.473 | 0.473 |
| EP34 (mm) | 0.657 | 0.657 |
| EP45 (mm) | 0.669 | 0.669 |
| EP56 (mm) | 0.711 | 0.711 |
| L (mm) | 6.949 | 7.049 |

In Embodiment 1, the object-side surface S1 of the first lens is a concave surface, and the image-side surface S2 of the first lens is a concave surface. The object-side surface S3 of the second lens is a convex surface, and the image-side surface S4 of the second lens is a convex surface. The object-side surface S5 of the third lens is a convex surface, and the image-side surface S6 of the third lens is a convex surface. The object-side surface S7 of the fourth lens is a convex surface, and the image-side surface S8 of the fourth lens is a concave surface. The object-side surface S9 of the fifth lens is a convex surface, and the image-side surface S10 of the fifth lens is a convex surface. The object-side surface S11 of the sixth lens is a convex surface, and the image-side surface S12 of the sixth lens is a convex surface. The object-side surface S13 of the seventh lens is a convex surface, and an image-side surface S14 of the seventh lens is a concave surface.

In Embodiment 1, an effective focal length f1 of the first lens is −2.54 mm, an effective focal length f2 of the second lens is 4.50 mm, an effective focal length f3 of the third lens is 2.48 mm, an effective focal length f4 of the fourth lens is −3.45 mm, an effective focal length f5 of the fifth lens is 22.77 mm, an effective focal length f6 of the sixth lens is 2.13 mm, and an effective focal length f7 of the seventh lens is −2.92 mm. Half of a maximal field-of-view semi-fov of the optical camera lens assembly is 77.8°, a maximal effective radius DT12 of the image-side surface of the first lens is 1.50 mm, a maximal effective radius DT11 of the object-side surface of the first lens is 2.50 mm, and a combined focal length f23 of the second lens and the third lens is 1.92 mm. An axial distance SAG32 from an intersection point of the image-side surface of the third lens and the optical axis to a projection point of an effective radius vertex of the image-side surface of the third lens onto the optical axis is −0.19 mm, and an axial distance SAG42 from an intersection point of the image-side surface of the fourth lens and the optical axis to a projection point of an effective radius vertex of the image-side surface of the fourth lens onto the optical axis is 0.18 mm. A maximal effective radius DT41 of the object-side surface of the fourth lens is 0.99 mm, a maximal effective radius DT51 of the object-side surface of the fifth lens is 1.29 mm, and a combined focal length f56 of the fifth lens and the sixth lens is 2.01 mm.

Table 2 is a table showing basic structure parameters of the optical camera lens assembly of Embodiment 1. Here, the units of a radius of curvature and a thickness/distance are millimeters (mm).

TABLE 2

| | | | | material | | |
|---|---|---|---|---|---|---|
| surface | surface | radius of | | refractive | abbe | conic |
| number | type | curvature | thickness | index | number | coefficient |
| OBJ | | infinite | infinite | | | |
| S1 | aspheric | −4.6298 | 0.3800 | 1.54 | 55.90 | 0.4218 |
| S2 | aspheric | 2.0340 | 0.7570 | | | −1.0206 |
| S3 | aspheric | 3.2527 | 1.5075 | 1.59 | 28.60 | −1.5407 |
| S4 | aspheric | −12.0609 | 0.1205 | | | 43.6677 |
| STO | | infinite | 0.0000 | | | |
| S5 | aspheric | 3.5723 | 0.6241 | 1.54 | 55.90 | −2.4080 |
| S6 | aspheric | −2.0453 | 0.0300 | | | 0.4988 |
| S7 | aspheric | 15.3419 | 0.2800 | 1.66 | 20.30 | −80.0000 |
| S8 | aspheric | 1.9866 | 0.2611 | | | −4.2766 |
| S9 | aspheric | 80.5307 | 0.5474 | 1.54 | 55.90 | 0.0000 |
| S10 | aspheric | −14.6544 | 0.3783 | | | 30.8826 |
| S11 | aspheric | 26.4028 | 0.6040 | 1.54 | 55.90 | 80.0000 |
| S12 | aspheric | −1.2044 | 0.0500 | | | −1.9403 |
| S13 | aspheric | 2.0068 | 0.3900 | 1.64 | 23.50 | −1.0065 |
| S14 | aspheric | 0.8967 | 0.8720 | | | −4.9893 |
| S15 | | infinite | 0.2100 | 1.51 | 64.10 | |
| S16 | | infinite | 0.6380 | | | |
| S17 | | infinite | | | | |

In Embodiment 1, the object-side surfaces and the image-side surfaces of the first to seventh lenses are all aspheric surfaces, and the surface type of each aspheric lens may be defined using, but not limited to, the following formula:

$$x = \frac{{ch}^{2}}{1 + \sqrt{1 - ( k + 1 ) {c}^{2} {h}^{2}}} + \sum {Aih}^{i} . \qquad ( 1 )$$

Here, x is the sag—the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 1 above); k is the conic coefficient; and Ai is the correction coefficient of an i-th order of the aspheric surface. Table 3 below shows the high-order coefficients A4, A6, A8, A10, A12, A14, A16, A18, A20, A22, A24, A26, A28and A30 applicable to the aspheric surfaces S1-S14 in Embodiment 1.

TABLE 3

| surface number | A4 | A6 | A8 | A10 | A12 | A14 | A16 |
|---|---|---|---|---|---|---|---|
| S1 | 9.3615E−01 | −1.9391E−01 | 6.4160E−02 | −2.5675E−02 | 1.0740E−02 | −4.8099E−03 | 2.1331E−03 |
| S2 | 2.9916E−01 | −6.6647E−02 | 1.0319E−02 | −1.5782E−03 | 1.9494E−03 | 3.2951E−04 | 9.8454E−05 |
| S3 | −1.9396E−01 | −5.7921E−03 | 6.6917E−03 | 7.6247E−04 | 2.4871E−05 | −1.8048E−04 | 1.8056E−05 |
| S4 | −2.3502E−02 | 5.1044E−03 | 1.2315E−03 | −4.5417E−06 | 1.0305E−04 | −6.6611E−06 | 1.1216E−05 |
| S5 | 1.6637E−02 | 3.5012E−03 | 1.6269E−03 | 5.3700E−05 | 6.8878E−05 | 1.4630E−05 | 8.9296E−06 |
| S6 | 7.9921E−02 | −2.0268E−02 | 1.3092E−02 | −3.8214E−03 | 2.4268E−03 | −7.3524E−04 | 5.3581E−04 |
| S7 | −1.1795E−01 | −1.9521E−02 | 9.6940E−03 | −5.1482E−03 | 2.0411E−03 | −7.5130E−04 | 4.7575E−04 |
| S8 | −1.1156E−01 | 9.6784E−03 | 6.4772E−04 | −2.0337E−03 | 6.2877E−04 | −2.8672E−04 | 8.9883E−05 |
| S9 | 2.6521E−02 | 1.3343E−02 | 2.3846E−03 | 3.8146E−04 | −5.8746E−04 | −2.8286E−04 | −1.1885E−04 |
| S10 | −2.0384E−01 | 4.8724E−02 | 7.8439E−03 | 3.3204E−03 | 6.3168E−04 | −1.0253E−04 | −5.3044E−04 |
| S11 | −1.9909E−01 | 9.9010E−03 | −6.2994E−03 | −9.5126E−03 | −5.8636E−04 | 2.5344E−03 | −3.1955E−04 |
| S12 | 7.9683E−01 | −1.5652E−01 | 2.9663E−02 | −2.6968E−02 | 9.5242E−03 | 2.3344E−03 | −1.1066E−03 |
| S13 | −1.6873E+00 | 2.3003E−01 | −5.1314E−02 | 1.9482E−02 | −6.7398E−03 | 6.5017E−03 | −3.0441E−03 |
| S14 | −1.0279E+00 | 5.2283E−02 | −3.5238E−02 | 9.5222E−03 | −2.7101E−03 | 4.5273E−03 | −1.1394E−03 |
| surface number | A18 | A20 | A22 | A24 | A26 | A28 | A30 |
| S1 | −9.6384E−04 | 4.3651E−04 | −1.8933E−04 | 9.0695E−05 | −3.2877E−05 | 1.2378E−05 | −5.3536E−06 |
| S2 | 1.3754E−05 | −5.8094E−05 | −1.6134E−05 | −3.2098E−05 | 6.7212E−08 | −3.9856E−06 | 3.1593E−06 |
| S3 | −2.9691E−05 | 1.5532E−05 | −7.0201E−06 | 8.3567E−06 | −6.0542E−06 | 3.2262E−06 | −1.5163E−06 |
| S4 | −2.4775E−06 | 3.1927E−06 | −2.1868E−06 | 4.6535E−06 | 1.7580E−06 | 1.9448E−06 | −3.2083E−06 |
| S5 | 4.9041E−06 | −2.5918E−08 | −1.8145E−06 | −4.8576E−06 | −1.4526E−06 | 5.6177E−07 | −1.3545E−06 |
| S6 | −1.5482E−04 | 1.2558E−04 | −4.0790E−05 | 2.4846E−05 | −1.8244E−05 | 4.1501E−06 | −1.0094E−05 |
| S7 | −1.4641E−04 | 1.1517E−04 | −3.8004E−05 | 2.2294E−05 | −1.5657E−05 | 2.7949E−06 | −3.2712E−06 |
| S8 | −2.5315E−05 | 1.6558E−05 | −8.3565E−06 | −2.1240E−07 | −3.5472E−06 | 1.8096E−06 | 1.0619E−06 |
| S9 | 1.8452E−05 | −1.1685E−05 | 4.4306E−07 | −1.5304E−05 | 1.9950E−06 | −1.8799E−06 | 5.1121E−06 |
| S10 | −2.9888E−04 | −1.3579E−04 | −3.1581E−05 | 3.0161E−06 | 1.0795E−05 | 8.3462E−06 | 4.9097E−06 |
| S11 | −1.7557E−04 | 8.8571E−05 | 1.8238E−05 | 8.8053E−06 | −9.3701E−06 | 1.4241E−05 | −3.0734E−06 |
| S12 | −7.1847E−04 | 6.9311E−04 | −6.4270E−05 | 5.4030E−05 | −9.0814E−05 | 6.2359E−05 | −2.3090E−05 |
| S13 | 2.3241E−03 | −1.7926E−03 | 6.2845E−04 | −4.2811E−04 | 2.6548E−04 | −6.9777E−05 | 3.1237E−06 |
| S14 | 2.0021E−03 | −1.3189E−03 | 4.4386E−04 | −5.8920E−04 | 2.1343E−04 | −1.3695E−04 | 4.7500E−05 |

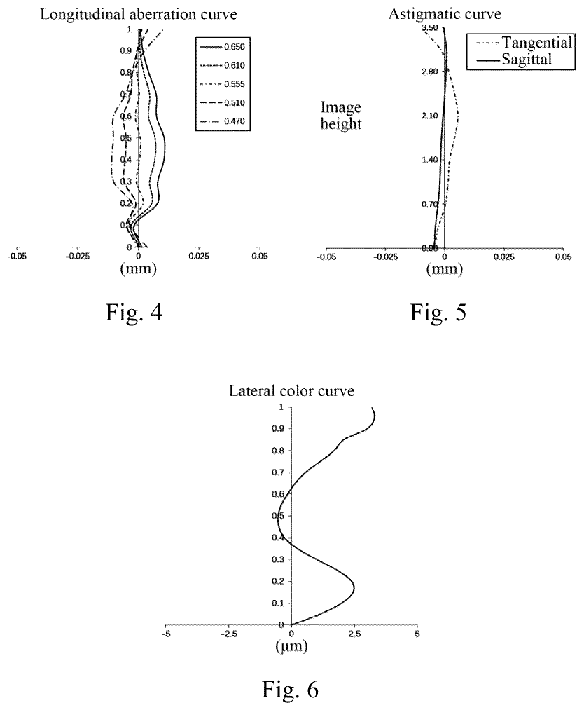

FIG. 4 illustrates a longitudinal aberration curve of the optical camera lens assembly of Embodiment 1, representing deviations of focal points of light of different wavelengths converged after passing through the optical camera lens assembly. FIG. 5 illustrates an astigmatic curve of the optical camera lens assembly of Embodiment 1, representing a curvature of a tangential image plane and a curvature of a sagittal image plane. FIG. 6 illustrates a lateral color curve of the optical camera lens assembly of Embodiment 1, representing deviations of different image heights on the image plane after light passes through the optical camera lens assembly.

It can be seen from FIGS. 4-6 that the optical camera lens assembly given in Embodiment 1 can achieve a good imaging quality.

### Embodiment 2

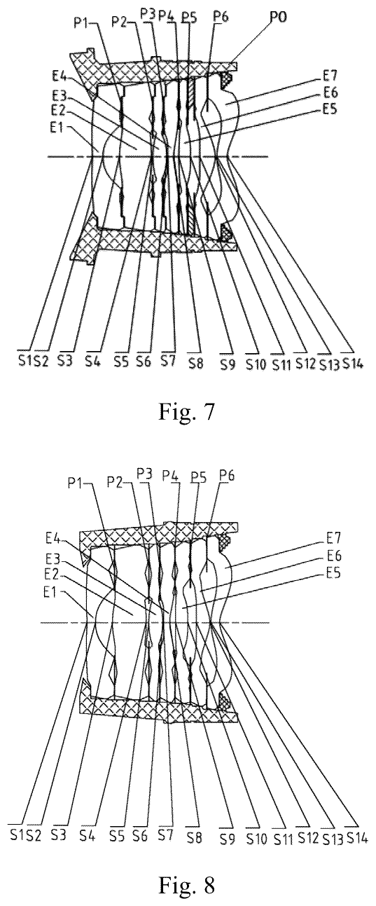

As shown in FIGS. 7-11, an optical camera lens assembly of Embodiment 2 is described. FIG. 7 is a schematic structural diagram of the optical camera lens assembly in a first state of Embodiment 2, and FIG. 8 is a schematic structural diagram of the optical camera lens assembly in a second state of Embodiment 2.

As shown in FIGS. 7 and 8, the optical camera lens assembly includes a lens barrel P0, and a first lens E1, a first spacing piece P1, a second lens E2, a second spacing piece P2, a third lens E3, a third spacing piece P3, a fourth lens E4, a fourth spacing piece P4, a fifth lens E5, a fifth spacing piece P5, a sixth lens E6, a sixth spacing piece P6 and a seventh lens E7, that are sequentially disposed in the lens barrel P along an optical axis of the lens barrel P0 from an object side to an image side.

As shown in FIG. 7, in the optical camera lens assembly in the first state, an object-side surface S1 of the first lens is partially against the lens barrel P0. An object-side surface and image-side surface of the first spacing piece P1 are partially against an image-side surface S2 of the first lens and an object-side surface S3 of the second lens, respectively. An object-side surface and image-side surface of the second spacing piece P2 are partially against an image-side surface S4 of the second lens and an object-side surface S5 of the third lens, respectively. An object-side surface and image-side surface of the third spacing piece P3 are partially against an image-side surface S6 of the third lens and an object-side surface S7 of the fourth lens, respectively. An object-side surface and image-side surface of the fourth spacing piece P4 are partially against an image-side surface S8 of the fourth lens and an object-side surface S9 of the fifth lens, respectively. An object-side surface and image-side surface of the fifth spacing piece P5 are partially against an image-side surface S10 of the fifth lens and an object-side surface S11 of the sixth lens, respectively. An object-side surface and image-side surface of the sixth spacing piece P6 are partially against an image-side surface S12 of the sixth lens and an object-side surface S13 of the seventh lens, respectively. As shown in FIG. 8, the support approach of the spacing pieces in the optical camera lens assembly in the second state is the same as that in the first state. Accordingly, for the support approach, reference may be made to the related description of the optical camera lens assembly in the first state, and thus the support approach will not be repeatedly described here.

In summary, the structure parameters of the optical camera lens assembly of Embodiment 2 in the first state 2-1 and the second state 2-2 are shown in Table 4. (Unit: mm)

TABLE 4

state

| parameter | 2-1 | 2-2 |
|---|---|---|
| d1s (mm) | 2.848 | 2.848 |
| D1s (mm) | 4.163 | 5.478 |
| d2s (mm) | 1.682 | 1.682 |
| D3m (mm) | 5.465 | 5.465 |
| D4m (mm) | 7.120 | 7.120 |
| d5s (mm) | 2.958 | 2.958 |
| d6s (mm) | 4.182 | 4.182 |
| CP4 (mm) | 0.018 | 0.018 |
| CP5 (mm) | 0.018 | 0.018 |
| EP01 (mm) | 1.119 | 1.119 |
| EP12 (mm) | 1.417 | 1.417 |
| EP23 (mm) | 0.484 | 0.484 |
| EP34 (mm) | 0.692 | 0.692 |
| EP45 (mm) | 0.400 | 0.400 |
| EP56 (mm) | 0.888 | 0.888 |
| L (mm) | 7.729 | 6.866 |

In Embodiment 2, the object-side surface S1 of the first lens is a concave surface, and the image-side surface S2 of the first lens is a concave surface. The object-side surface S3 of the second lens is a convex surface, and the image-side surface S4 of the second lens is a convex surface. The object-side surface S5 of the third lens is a convex surface, and the image-side surface S6 of the third lens is a convex surface. The object-side surface S7 of the fourth lens is a convex surface, and the image-side surface S8 of the fourth lens is a concave surface. The object-side surface S9 of the fifth lens is a convex surface, and the image-side surface S10 of the fifth lens is a convex surface. The object-side surface S11 of the sixth lens is a convex surface, and the image-side surface S12 of the sixth lens is a convex surface. The object-side surface S13 of the seventh lens is a convex surface, and an image-side surface S14 of the seventh lens is a concave surface.

In Embodiment 2, an effective focal length f1 of the first lens is −2.60 mm, an effective focal length f2 of the second lens is 5.51 mm, an effective focal length f3 of the third lens is 2.59 mm, an effective focal length f4 of the fourth lens is −3.81 mm, an effective focal length f5 of the fifth lens is 11.91 mm, an effective focal length f6 of the sixth lens is 2.28 mm, and an effective focal length f7 of the seventh lens is −3.06 mm. Half of a maximal field-of-view semi-fov of the optical camera lens assembly is 77.5°, a maximal effective radius DT12 of the image-side surface of the first lens is 1.46 mm, a maximal effective radius DT11 of the object-side surface of the first lens is 2.58 mm, and a combined focal length f23 of the second lens and the third lens is 2.06 mm. An axial distance SAG32 from an intersection point of the image-side surface of the third lens and the optical axis to a projection point of an effective radius vertex of the image-side surface of the third lens onto the optical axis is −0.22 mm, and an axial distance SAG42 from an intersection point of the image-side surface of the fourth lens and the optical axis to a projection point of an effective radius vertex of the image-side surface of the fourth lens onto the optical axis is 0.16 mm. A maximal effective radius DT41 of the object-side surface of the fourth lens is 1.03 mm, a maximal effective radius DT51 of the object-side surface of the fifth lens is 1.33 mm, and a combined focal length f56 of the fifth lens and the sixth lens is 2.09 mm.

Table 5 is a table showing basic structure parameters of the optical camera lens assembly of Embodiment 2. Here, the units of a radius of curvature and a thickness/distance are millimeters (mm).

TABLE 5

| | | | | material | | |
|---|---|---|---|---|---|---|
| surface | surface | radius of | | refractive | abbe | conic |
| number | type | curvature | thickness | index | number | coefficient |
| OBJ | | infinite | infinite | | | |
| S1 | aspheric | −6.4173 | 0.4891 | 1.54 | 55.90 | 1.0087 |
| S2 | aspheric | 1.8716 | 0.7632 | | | −0.7468 |
| S3 | aspheric | 3.5150 | 1.4800 | 1.59 | 28.60 | −0.4118 |
| S4 | aspheric | −36.5467 | 0.0597 | | | −71.2580 |
| STO | | infinite | 0.0061 | | | |
| S5 | aspheric | 3.0493 | 0.6487 | 1.54 | 55.90 | −11.0761 |
| S6 | aspheric | −2.4430 | 0.0450 | | | 2.2188 |
| S7 | aspheric | 149.5206 | 0.2800 | 1.66 | 20.30 | −80.0000 |
| S8 | aspheric | 2.4963 | 0.2323 | | | −3.5900 |
| S9 | aspheric | 7.8073 | 0.5431 | 1.54 | 55.90 | −4.3226 |
| S10 | aspheric | −37.8874 | 0.4297 | | | −68.3573 |
| S11 | aspheric | 67.6619 | 0.7181 | 1.54 | 55.90 | −80.0000 |
| S12 | aspheric | −1.2653 | 0.0800 | | | −1.4271 |
| S13 | aspheric | 2.4555 | 0.4809 | 1.64 | 23.50 | −0.0219 |
| S14 | aspheric | 1.0093 | 0.8386 | | | −4.3544 |
| S15 | | infinite | 0.2100 | 1.51 | 64.10 | |
| S16 | | infinite | 0.6042 | | | |
| S17 | | infinite | | | | |

Table 6 below shows the high-order coefficients A4, A6, A8, A10, A12, A14, A16, A18, A20, A22, A24, A26, A28 and A30 applicable to the aspheric surfaces S1-S14 in Embodiment 2.

TABLE 6

| surface number | A4 | A6 | A8 | A10 | A12 | A14 | A16 |
|---|---|---|---|---|---|---|---|
| S1 | 7.5925E−01 | −1.6317E−01 | 5.1472E−02 | −1.9473E−02 | 7.7811E−03 | −3.3230E−03 | 1.3753E−03 |
| S2 | 2.7192E−01 | −4.4907E−02 | 2.1734E−03 | −1.8728E−03 | 8.9165E−04 | 3.7914E−04 | 8.1572E−05 |
| S3 | −1.4290E−01 | −8.1450E−03 | 2.8716E−03 | 6.7299E−04 | 1.6515E−04 | −8.1879E−05 | −2.7184E−05 |
| S4 | −3.7479E−02 | 6.6694E−03 | 1.7449E−04 | 1.1606E−04 | 3.6894E−05 | −1.4442E−05 | 1.0828E−05 |
| S5 | 3.5287E−03 | 5.9956E−03 | 5.3104E−04 | 3.0667E−04 | 3.5532E−05 | 2.3186E−05 | −4.9992E−06 |
| S6 | 3.2472E−02 | −8.9876E−03 | 8.8010E−03 | −9.3784E−04 | 1.3254E−03 | −1.1210E−04 | 1.9326E−04 |
| S7 | −1.2179E−01 | −1.0061E−02 | 6.0209E−03 | −1.9929E−03 | 9.8856E−04 | −2.0459E−04 | 1.5841E−04 |
| S8 | −1.1022E−01 | 1.2739E−02 | 7.3260E−05 | −8.5717E−04 | 2.4315E−04 | −1.2015E−04 | 3.7814E−05 |
| S9 | −5.7264E−02 | 2.2443E−02 | 4.9352E−05 | −4.9733E−04 | −3.3817E−04 | 2.9552E−05 | −2.1188E−05 |
| S10 | −1.9962E−01 | 4.8176E−02 | 5.1588E−03 | −1.8281E−03 | −7.5775E−04 | 1.7260E−04 | 5.0712E−06 |
| S11 | −1.8432E−01 | 8.1247E−03 | 8.9870E−03 | −1.1895E−02 | −4.0476E−03 | 1.8171E−03 | 3.9406E−04 |
| S12 | 6.2290E−01 | −1.3248E−01 | 5.1594E−02 | −2.5811E−02 | 1.1779E−03 | 1.4218E−03 | 2.8786E−03 |
| S13 | −1.7880E+00 | 6.5522E−03 | −2.4622E−02 | −4.1812E−03 | 3.5543E−03 | −2.0854E−03 | −6.7448E−04 |
| S14 | −1.0899E+00 | 7.2838E−02 | −2.9017E−02 | 8.1562E−03 | 9.1450E−05 | 8.4403E−04 | −6.5645E−04 |
| surface number | A18 | A20 | A22 | A24 | A26 | A28 | A30 |
| S1 | −5.8360E−04 | 2.5525E−04 | −1.0640E−04 | 4.9270E−05 | −1.7898E−05 | 7.4213E−06 | −1.6704E−06 |
| S2 | 6.5209E−06 | −3.7129E−05 | −1.4229E−05 | −1.7841E−05 | −2.0791E−06 | 1.8126E−06 | 9.4916E−07 |
| S3 | −6.3658E−06 | −1.5911E−06 | 4.8803E−06 | −2.8682E−06 | −1.1598E−07 | −2.9118E−07 | 3.1755E−07 |
| S4 | −9.8999E−06 | 7.3912E−06 | −4.3102E−06 | 3.5986E−06 | −1.9233E−06 | 1.8983E−06 | −6.3173E−07 |
| S5 | −2.5440E−06 | −3.8114E−06 | −1.8164E−06 | −8.6681E−07 | −1.7136E−06 | 1.0956E−06 | −6.5774E−08 |
| S6 | −5.7655E−05 | −6.2115E−07 | −2.5079E−05 | −9.9545E−06 | −5.4111E−06 | 2.7364E−06 | 9.6050E−07 |
| S7 | −6.0932E−05 | −5.2477E−07 | −2.1607E−05 | −4.2374E−06 | −3.3142E−06 | 1.2421E−06 | 1.6894E−06 |
| S8 | −3.8333E−05 | −3.9641E−07 | −9.0384E−06 | 3.7642E−06 | −4.1264E−07 | 2.7027E−06 | 9.3767E−09 |
| S9 | −1.8161E−06 | −1.9780E−05 | 4.6842E−06 | −5.1837E−06 | 1.2551E−06 | 5.3815E−07 | 5.4854E−07 |
| S10 | −3.7837E−05 | −3.5684E−05 | −1.0295E−05 | 4.3872E−06 | 4.5611E−06 | −8.1399E−07 | 2.3934E−07 |
| S11 | −1.3977E−04 | −5.5794E−05 | 1.0310E−04 | −1.1652E−05 | −3.3729E−06 | −2.9786E−06 | 9.9890E−06 |
| S12 | −7.8632E−04 | 4.4219E−05 | −1.6959E−04 | 6.4757E−05 | −6.3487E−05 | 9.6208E−06 | 5.6368E−06 |
| S13 | −1.3669E−03 | 1.5687E−04 | −4.4395E−04 | 1.0513E−04 | −4.5393E−05 | 9.5920E−05 | −4.6099E−05 |
| S14 | 5.5089E−04 | −2.0967E−04 | 1.0390E−05 | −5.3494E−05 | 7.2272E−05 | −1.9606E−05 | 3.1964E−06 |

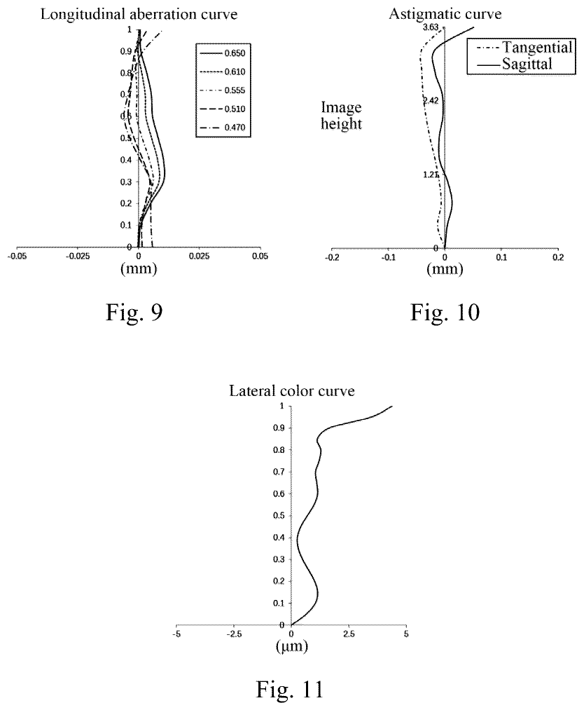

FIG. 9 illustrates a longitudinal aberration curve of the optical camera lens assembly of Embodiment 2, representing deviations of focal points of light of different wavelengths converged after passing through the optical camera lens assembly. FIG. 10 illustrates an astigmatic curve of the optical camera lens assembly of Embodiment 2, representing a curvature of a tangential image plane and a curvature of a sagittal image plane. FIG. 11 illustrates a lateral color curve of the optical camera lens assembly of Embodiment 2, representing deviations of different image heights on the image plane after light passes through the optical camera lens assembly.

It can be seen from FIGS. 9-11 that the optical camera lens assembly given in Embodiment 2 can achieve a good imaging quality.

### Embodiment 3

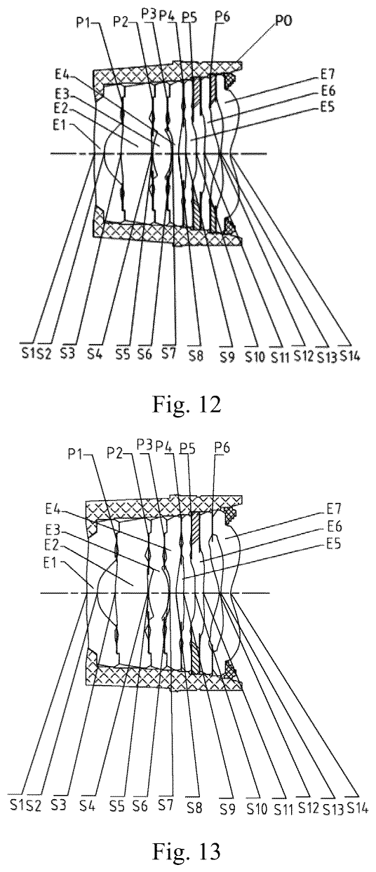

As shown in FIGS. 12-16, an optical camera lens assembly of Embodiment 3 is described. FIG. 12 is a schematic structural diagram of the optical camera lens assembly in a first state of Embodiment 3, and FIG. 13 is a schematic structural diagram of the optical camera lens assembly in a second state of Embodiment 3.

As shown in FIGS. 12 and 13, the optical camera lens assembly includes a lens barrel P0, and a first lens E1, a first spacing piece P1, a second lens E2, a second spacing piece P2, a third lens E3, a third spacing piece P3, a fourth lens E4, a fourth spacing piece P4, a fifth lens E5, a fifth spacing piece P5, a sixth lens E6, a sixth spacing piece P6 and a seventh lens E7, that are sequentially disposed in the lens barrel PO along an optical axis of the lens barrel P0 from an object side to an image side.

As shown in FIG. 12, in the optical camera lens assembly in the first state, an object-side surface S1 of the first lens is partially against the lens barrel P0. An object-side surface and image-side surface of the first spacing piece P1 are partially against an image-side surface S2 of the first lens and an object-side surface S3 of the second lens, respectively. An object-side surface and image-side surface of the second spacing piece P2 are partially against an image-side surface S4 of the second lens and an object-side surface S5 of the third lens, respectively. An object-side surface and image-side surface of the third spacing piece P3 are partially against an image-side surface S6 of the third lens and an object-side surface S7 of the fourth lens, respectively. An object-side surface and image-side surface of the fourth spacing piece P4 are partially against an image-side surface S8 of the fourth lens and an object-side surface S9 of the fifth lens, respectively. An object-side surface and image-side surface of the fifth spacing piece P5 are partially against an image-side surface S10 of the fifth lens and an object-side surface S11 of the sixth lens, respectively. An object-side surface and image-side surface of the sixth spacing piece P6 are partially against an image-side surface S12 of the sixth lens and an object-side surface S13 of the seventh lens, respectively.

As shown in FIG. 13, the support approach of the spacing pieces in the optical camera lens assembly in the second state is the same as that in the first state. Accordingly, for the support approach, reference may be made to the related description of the optical camera lens assembly in the first state, and thus the support approach will not be repeatedly described here.

In summary, the structure parameters of the optical camera lens assembly of Embodiment 3 in the first state 3-1 and the second state 3-3 are shown in Table 7. (Unit: mm)

TABLE 7

state

| parameter | 3-1 | 3-2 |
|---|---|---|
| d1s (mm) | 2.804 | 2.804 |
| D1s (mm) | 5.284 | 5.284 |
| d2s (mm) | 1.659 | 1.659 |
| D3m (mm) | 5.272 | 5.272 |
| D4m (mm) | 6.920 | 6.920 |
| d5s (mm) | 3.020 | 3.020 |
| d6s (mm) | 4.322 | 4.597 |
| CP4 (mm) | 0.018 | 0.018 |
| CP5 (mm) | 0.018 | 0.018 |
| EP01 (mm) | 0.883 | 0.883 |
| EP12 (mm) | 1.407 | 1.407 |
| EP23 (mm) | 0.683 | 0.683 |
| EP34 (mm) | 0.740 | 0.740 |
| EP45 (mm) | 0.438 | 0.438 |
| EP56 (mm) | 0.790 | 0.915 |
| L (mm) | 7.003 | 6.969 |

In Embodiment 3, the object-side surface S1 of the first lens is a concave surface, and the image-side surface S2 of the first lens is a concave surface. The object-side surface S3 of the second lens is a convex surface, and the image-side surface S4 of the second lens is a concave surface. The object-side surface S5 of the third lens is a convex surface, and the image-side surface S6 of the third lens is a convex surface. The object-side surface S7 of the fourth lens is a convex surface, and the image-side surface S8 of the fourth lens is a concave surface. The object-side surface S9 of the fifth lens is a convex surface, and the image-side surface S10 of the fifth lens is a concave surface. The object-side surface S11 of the sixth lens is a convex surface, and the image-side surface S12 of the sixth lens is a convex surface. The object-side surface S13 of the seventh lens is a convex surface, and an image-side surface S14 of the seventh lens is a concave surface.

In Embodiment 3, an effective focal length f1 of the first lens is −2.64 mm, an effective focal length f2 of the second lens is 16.79 mm, an effective focal length f3 of the third lens is 1.99 mm, an effective focal length f4 of the fourth lens is −4.41 mm, an effective focal length f5 of the fifth lens is 25.77 mm, an effective focal length f6 of the sixth lens is 2.12 mm, and an effective focal length f7 of the seventh lens is −2.55 mm. Half of a maximal field-of-view semi-fov of the optical camera lens assembly is 78.1°, a maximal effective radius DT12 of the image-side surface of the first lens is 1.43 mm, a maximal effective radius DT11 of the object-side surface of the first lens is 2.41 mm, and a combined focal length f23 of the second lens and the third lens is 2.01 mm. An axial distance SAG32 from an intersection point of the image-side surface of the third lens and the optical axis to a projection point of an effective radius vertex of the image-side surface of the third lens onto the optical axis is −0.28 mm, and an axial distance SAG42 from an intersection point of the image-side surface of the fourth lens and the optical axis to a projection point of an effective radius vertex of the image-side surface of the fourth lens onto the optical axis is 0.14 mm. A maximal effective radius DT41 of the object-side surface of the fourth lens is 1.06 mm, a maximal effective radius DT51 of the object-side surface of the fifth lens is 1.32 mm, and a combined focal length f56 of the fifth lens and the sixth lens is 2.07 mm.

Table 8 is a table showing basic structure parameters of the optical camera lens assembly of Embodiment 3. Here, the units of a radius of curvature and a thickness/distance are millimeters (mm).

TABLE 8

| | | | | material | | |
|---|---|---|---|---|---|---|
| surface | surface | radius of | | refractive | abbe | conic |
| number | type | curvature | thickness | index | number | coefficient |
| OBJ | | infinite | infinite | | | |
| S1 | aspheric | −5.5948 | 0.4612 | 1.54 | 55.90 | 1.7152 |
| S2 | aspheric | 1.9918 | 0.7935 | | | −0.0907 |
| S3 | aspheric | 5.0663 | 1.4532 | 1.59 | 28.60 | 2.4132 |
| S4 | aspheric | 8.8034 | 0.0425 | | | 9.8311 |
| STO | | infinite | 0.0000 | | | |
| S5 | aspheric | 1.6796 | 0.9000 | 1.54 | 55.90 | 0.0251 |
| S6 | aspheric | −2.4820 | 0.0450 | | | 2.7707 |
| S7 | aspheric | 35.9068 | 0.2800 | 1.66 | 20.30 | −67.9980 |
| S8 | aspheric | 2.7087 | 0.3347 | | | −3.4797 |
| S9 | aspheric | 7.1074 | 0.5056 | 1.54 | 55.90 | −50.9447 |
| S10 | aspheric | 14.0092 | 0.3861 | | | −6.2714 |
| S11 | aspheric | 11.3872 | 0.6949 | 1.54 | 55.90 | −54.2875 |
| S12 | aspheric | −1.2613 | 0.0800 | | | −1.9182 |
| S13 | aspheric | 2.4018 | 0.4400 | 1.64 | 23.50 | −0.6249 |
| S14 | aspheric | 0.9055 | 0.7088 | | | −4.7288 |
| S15 | | infinite | 0.2100 | 1.51 | 64.10 | |
| S16 | | infinite | 0.4741 | | | |
| S17 | | infinite | | | | |

Table 9 below shows the high-order coefficients A4, A6, A8, A10, A12, A14, A16, A18, A20, A22, A24, A26, A28 and A30 applicable to the aspheric surfaces S1-S14 in Embodiment 3.

TABLE 9

| surface number | A4 | A6 | A8 | A10 | A12 | A14 | A16 |
|---|---|---|---|---|---|---|---|
| S1 | 8.2511E−01 | −2.0068E−01 | 6.6266E−02 | −2.1090E−02 | 7.3146E−03 | −3.2016E−03 | 1.1983E−03 |
| S2 | 2.8692E−01 | −9.4175E−02 | 4.0505E−03 | 5.3075E−03 | 3.1351E−03 | 4.9243E−04 | −2.7420E−04 |
| S3 | −1.0835E−01 | −9.4092E−03 | 5.4037E−03 | 2.2133E−03 | −1.3212E−04 | −3.3347E−04 | −1.1772E−04 |
| S4 | −7.3274E−02 | 1.1979E−02 | −1.9884E−03 | 7.4590E−04 | −2.4914E−04 | 7.9101E−05 | −3.3617E−05 |
| S5 | −1.0715E−01 | 1.4145E−02 | −3.3414E−03 | 1.2486E−03 | −4.0311E−04 | 1.5520E−04 | −6.2818E−05 |
| S6 | 1.3973E−03 | −7.7146E−03 | 1.0166E−02 | −2.5088E−03 | 1.3269E−03 | −5.6344E−04 | 2.8612E−04 |
| S7 | −1.7354E−01 | −5.6186E−03 | 9.1475E−03 | −3.5033E−03 | 1.0089E−03 | −5.7111E−04 | 2.9585E−04 |
| S8 | −1.1252E−01 | 1.4210E−02 | 1.2310E−03 | −2.3484E−03 | 2.9520E−04 | −2.7096E−04 | 1.8699E−04 |
| S9 | −1.1870E−01 | 9.7485E−03 | 6.6062E−03 | −1.0203E−03 | −1.2120E−03 | −7.8174E−04 | −6.8131E−05 |
| S10 | −3.2340E−01 | 4.1688E−02 | 2.0326E−02 | 2.1435E−05 | −1.6080E−03 | −1.3425E−03 | −2.2499E−04 |
| S11 | −2.0611E−01 | −1.4182E−02 | 8.3551E−03 | −2.0195E−02 | −1.1458E−03 | 3.1234E−03 | 1.2492E−03 |
| S12 | 9.8365E−01 | −2.1395E−01 | 3.0833E−02 | −2.9128E−02 | 1.5596E−02 | 9.1476E−04 | 1.0881E−03 |
| S13 | −1.9223E+00 | 3.1237E−01 | −7.0279E−02 | 3.7803E−02 | −1.4548E−02 | 4.5734E−03 | −2.2403E−04 |
| S14 | −1.3822E+00 | 1.7458E−01 | −8.1074E−02 | 4.4617E−02 | −1.2569E−02 | 6.8203E−03 | −2.1797E−03 |
| surface number | A18 | A20 | A22 | A24 | A26 | A28 | A30 |
| S1 | −4.9023E−04 | 2.2133E−04 | −6.9238E−05 | 3.9467E−05 | −1.2106E−05 | 1.3612E−06 | −1.3482E−06 |
| S2 | −1.6478E−04 | −1.7991E−04 | −7.0023E−05 | −5.1010E−05 | 6.4267E−06 | 1.0057E−05 | 8.3367E−06 |
| S3 | 8.5546E−06 | 1.0364E−05 | 2.0546E−05 | −1.2143E−06 | −3.8333E−07 | −3.7490E−06 | 1.1854E−06 |
| S4 | 7.9873E−06 | −3.8114E−06 | −1.6772E−08 | 2.2385E−06 | 7.6589E−07 | −4.0450E−07 | −6.6615E−08 |
| S5 | 2.2926E−05 | −7.7973E−06 | 2.1029E−06 | −3.1562E−06 | −8.1950E−07 | 1.7447E−06 | −4.0409E−07 |
| S6 | −1.4410E−04 | 3.1517E−05 | −2.0957E−05 | 1.4707E−05 | −1.2841E−06 | 3.8855E−06 | −1.9503E−06 |
| S7 | −1.1078E−04 | 3.0446E−05 | −1.0297E−05 | 1.9453E−05 | 3.5170E−06 | 3.0960E−06 | −4.1964E−06 |
| S8 | −3.5766E−05 | 2.5721E−05 | −2.1764E−06 | 1.1431E−05 | −2.2963E−06 | 3.7413E−06 | −3.1274E−06 |
| S9 | 5.9939E−05 | 2.2768E−05 | −3.7211E−06 | −9.0150E−06 | 7.9706E−06 | 3.5698E−06 | 9.8927E−07 |
| S10 | 3.2213E−05 | 1.6024E−04 | 5.7473E−05 | 2.0353E−05 | −1.3342E−05 | −3.5895E−06 | −3.6125E−06 |
| S11 | −3.1210E−04 | 4.5748E−04 | 2.9123E−04 | −4.7572E−05 | −8.7500E−05 | −2.2258E−05 | −1.0710E−05 |
| S12 | −2.3911E−03 | 1.4279E−03 | −4.1273E−04 | −2.1446E−04 | −8.1850E−05 | 1.3998E−04 | −1.9991E−05 |
| S13 | −7.9213E−04 | −6.1231E−04 | −2.4178E−04 | 2.9154E−04 | 2.2588E−05 | 6.7105E−05 | −3.7010E−05 |
| S14 | 1.0795E−03 | −9.5968E−04 | 1.0247E−04 | −2.2835E−04 | 6.4959E−05 | 1.0554E−05 | 2.3938E−05 |

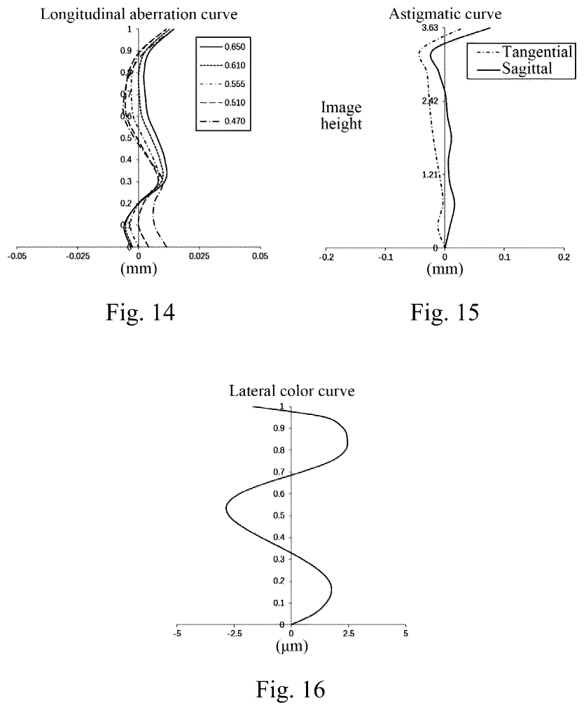

FIG. 14 illustrates a longitudinal aberration curve of the optical camera lens assembly of Embodiment 3, representing deviations of focal points of light of different wavelengths converged after passing through the optical camera lens assembly. FIG. 15 illustrates an astigmatic curve of the optical camera lens assembly of Embodiment 3, representing a curvature of a tangential image plane and a curvature of a sagittal image plane. FIG. 16 illustrates a lateral color curve of the optical camera lens assembly of Embodiment 3, representing deviations of different image heights on the image plane after light passes through the optical camera lens assembly.

It can be seen from FIGS. 14-16 that the optical camera lens assembly given in Embodiment 3 can achieve a good imaging quality.

In summary, Embodiments 1-3 respectively satisfy the relationships shown in Table 10.

TABLE 10

| | Embodiment | | | | | |
|---|---|---|---|---|---|---|
| Conditional expression | 1-1 | 1-2 | 2-1 | 2-2 | 3-1 | 3-2 |
| TAN(Semi-FOV)/L | 0.67 | 0.66 | 0.58 | 0.66 | 0.68 | 0.68 |
| EP01*D1s/(f1*DT12) | −2.21 | −1.89 | −1.23 | −1.62 | −1.23 | −1.23 |
| f1*N1/d1s | −1.34 | −1.34 | −1.41 | −1.41 | −1.45 | −1.45 |
| (EP12 + CT2)/(EP01 + CT1) | 1.58 | 2.11 | 1.80 | 1.80 | 2.13 | 2.13 |
| R1/R3 + DT11/d1s | −0.57 | −0.57 | −0.92 | −0.92 | −0.25 | −0.25 |
| f23/d2s | 1.15 | 1.15 | 1.23 | 1.23 | 1.21 | 1.21 |
| SAG32/EP23 | −0.39 | −0.39 | −0.44 | −0.44 | −0.41 | −0.41 |
| SAG42/EP34 | 0.27 | 0.27 | 0.23 | 0.23 | 0.19 | 0.19 |
| (D4m − D3m)/(DT51 − DT41) | 5.61 | 0.33 | 5.47 | 5.47 | 6.20 | 6.20 |
| (CP4 + EP45 + CP5)/(f4*N4) | −0.12 | −0.12 | −0.07 | −0.07 | −0.06 | −0.06 |
| EP56/(R12*N6) | −0.38 | −0.38 | −0.45 | −0.45 | −0.41 | −0.47 |
| d5s/f56 | 1.53 | 1.53 | 1.41 | 1.41 | 1.46 | 1.46 |
| f7*N7/d6s | −1.07 | −1.07 | −1.20 | −1.20 | −0.97 | −0.91 |

It should be noted that, in Table 10, 1-1 represents that the optical camera lens assembly in Embodiment 1 is in the first state, 1-2 represents that the optical camera lens assembly in Embodiment 1 is in the second state, 2-1 represents that the optical camera lens assembly in Embodiment 2 is in the first state, 2-2 represents that the optical camera lens assembly in Embodiment 2 is in the second state, 3-1 represents that the optical camera lens assembly in Embodiment 3 is in the first state, and 3-2 represents that the optical camera lens assembly in Embodiment 3 is in the second state.

Table 11 shows the effective focal lengths f1-f7, etc. of the lenses of the optical camera lens assemblies of Embodiments 1-3.

TABLE 11

| | Embodiment | | |
|---|---|---|---|
| Parameter | 1 | 2 | 3 |
| f1 (mm) | −2.54 | −2.60 | −2.64 |
| f2 (mm) | 4.50 | 5.51 | 16.79 |
| f3 (mm) | 2.48 | 2.59 | 1.99 |
| f4 (mm) | −3.45 | −3.81 | −4.41 |
| f5 (mm) | 22.77 | 11.91 | 25.77 |
| f6 (mm) | 2.13 | 2.28 | 2.12 |
| f7 (mm) | −2.92 | −3.06 | −2.55 |
| Semi-FOV (°) | 77.8 | 77.5 | 78.1 |
| DT12 (mm) | 1.50 | 1.46 | 1.43 |
| DT11 (mm) | 2.50 | 2.58 | 2.41 |
| f23 (mm) | 1.92 | 2.06 | 2.01 |
| SAG32 (mm) | −0.19 | −0.22 | −0.28 |
| SAG42 (mm) | 0.18 | 0.16 | 0.14 |
| DT41 (mm) | 0.99 | 1.03 | 1.06 |
| DT51 (mm) | 1.29 | 1.33 | 1.32 |
| f56 (mm) | 2.01 | 2.09 | 2.07 |

Clearly, the embodiments described above are only part of the embodiments of the present disclosure, but not all of the embodiments. Based on the embodiments in the present disclosure, all other embodiments obtained by those of ordinary skill in the art without making creative efforts shall fall within the scope of protection of the present disclosure.

It should be noted that the terms used herein are for the purpose of describing specific implementations only, rather than limiting the exemplary implementations according to the present disclosure. As used herein, the singular form is intended to include the plural form as well, unless the context clearly indicates otherwise. Moreover, it should be understood that the terms “includes” and/or “comprises,” when used in this specification, specify the presence of the features, steps, operations, devices, components and/or combinations thereof.

It should be noted that the terms “first,” “second,” etc. in the specification and claims of the present disclosure and the accompanying drawings are used to distinguish similar objects, but not necessarily used to describe a specific order or sequential order. It should be understood that the data so used are interchangeable under appropriate circumstances such that the implementations of the present disclosure described herein can be performed in an order other than that illustrated or described herein.

The foregoing is only preferred embodiments of the present disclosure, and is not used to limit the present disclosure. For those skilled in the art, the present disclosure may have various alterations and changes. Any modifications, equivalent substitutions, improvements, etc. made within the spirit and principles of the present disclosure shall fall within the scope of protection of the present disclosure.

What is claimed is:

1. An optical camera lens assembly, comprising: a lens barrel, seven lenses and at least one spacing piece, wherein the seven lenses and the at least one spacing piece are disposed in the lens barrel,
the seven lenses sequentially comprise a first lens, a second lens, a third lens, a fourth lens, a fifth lens, a sixth lens and a seventh lens from an object side to an image side;
the at least one spacing piece comprises a first spacing piece, the first spacing piece is positioned between the first lens and the second lens and is in partial contact with an image-side surface of the first lens;
half of a maximal field-of-view Semi-FOV of the optical camera lens assembly and a maximal height L of the lens barrel satisfy: 0.5<TAN(Semi-FOV)/L<0.8; and
a spacing distance EP01 between an object-side end surface of the lens barrel and the first spacing piece, an outer diameter D1s of an object-side surface of the first spacing piece, an effective focal length f1 of the first lens, and a maximal effective radius DT12 of the image-side surface of the first lens satisfy:
−2.5<EP01*D1s/(f1*DT12)<−1.0.

2. The optical camera lens assembly according to claim 1, wherein
the first lens has a negative refractive power, an object-side surface of the first lens is a concave surface, and the image-side surface of the first lens is a concave surface;
the second lens has a positive refractive power, and an object-side surface of the second lens is a convex surface;
the third lens has a positive refractive power, an object-side surface of the third lens is a convex surface, and an image-side surface of the third lens is a convex surface;
the fourth lens has a negative refractive power, an object-side surface of the fourth lens is a convex surface, and an image-side surface of the fourth lens is a concave surface;
the fifth lens has a positive refractive power, and an object-side surface of the fifth lens is a convex surface;
the sixth lens has a positive refractive power, an object-side surface of the sixth lens is a convex surface, and an image-side surface of the sixth lens is a convex surface; and
the seventh lens has a negative refractive power, an object-side surface of the seventh lens is a convex surface, and an image-side surface of the seventh lens is a concave surface.

3. The optical camera lens assembly according to claim 1, wherein the effective focal length f1 of the first lens, a refractive index N1 of the first lens, and an inner diameter d1s of the object-side surface of the first spacing piece satisfy:
−1.5<f1*N1/d1s<−1.2.

4. The optical camera lens assembly according to claim 1, wherein the at least one spacing piece further comprises a second spacing piece, the second spacing piece is positioned between the second lens and the third lens and is in partial contact with an image-side surface of the second lens, and a spacing distance EP12 between the first spacing piece and the second spacing piece, a center thickness CT2 of the second lens on an optical axis, the spacing distance EP01 between the object-side end surface of the lens barrel and the first spacing piece, and a center thickness CT1 of the first lens on the optical axis satisfy: 1.5<(EP12+CT2)/(EP01+CT1)<2.2.

5. The optical camera lens assembly according to claim 1, wherein a radius of curvature R1 of an object-side surface of the first lens, a radius of curvature R3 of an object-side surface of the second lens, a maximal effective radius DT11 of the object-side surface of the first lens, and an inner diameter d1s of the object-side surface of first spacing piece satisfy: −1.0<R1/R3+DT11/d1s<−0.2.

6. The optical camera lens assembly according to claim 1, wherein the at least one spacing piece further comprises a second spacing piece, the second spacing piece is positioned between the second lens and the third lens and is in partial contact with an image-side surface of the second lens, and a combined focal length f23 of the second lens and the third lens, and an inner diameter d2s of an object-side surface of the second spacing piece satisfy: 1.0<f23/d2s<1.3.

7. The optical camera lens assembly according to claim 1, wherein the at least one spacing piece further comprises a second spacing piece and a third spacing piece, the second spacing piece is positioned between the second lens and the third lens and is in partial contact with an image-side surface of the second lens, and the third spacing piece is positioned between the third lens and the fourth lens and is in partial contact with an image-side surface of the third lens, wherein an axial distance SAG32 from an intersection point of the image-side surface of the third lens and an optical axis to a projection point of an effective radius vertex of the image-side surface of the third lens onto the optical axis, and a spacing distance EP23 between the second spacing piece and the third spacing piece satisfy:
−0.5<SAG32/EP23<−0.3.

8. The optical camera lens assembly according to claim 1, wherein the at least one spacing piece further comprises a third spacing piece and a fourth spacing piece, the third spacing piece is positioned between the third lens and the fourth lens and is in partial contact with an image-side surface of the third lens, and the fourth spacing piece is positioned between the fourth lens and the fifth lens and is in partial contact with an image-side surface of the fourth lens, wherein an axial distance SAG42 from an intersection point of the image-side surface of the fourth lens and an optical axis to onto the optical axis an effective radius vertex of the image-side surface of the fourth lens onto the optical axis and a spacing distance EP34 between the third spacing piece and the fourth spacing piece satisfy:
0.1<SAG42/EP34<0.3.

9. The optical camera lens assembly according to claim 1, wherein the at least one spacing piece further comprises a third spacing piece and a fourth spacing piece, the third spacing piece is positioned between the third lens and the fourth lens and is in partial contact with an image-side surface of the third lens, and the fourth spacing piece is positioned between the fourth lens and the fifth lens and is in partial contact with an image-side surface of the fourth lens, wherein an outer diameter D3m of an image-side surface of the third spacing piece, an outer diameter D4m of an image-side surface of the fourth spacing piece, a maximal effective radius DT41 of an object-side surface of the fourth lens, and a maximal effective radius DT51 of an object-side surface of the fifth lens satisfy: 0.3<(D4m−D3m)/(DT51−DT41)≤6.20.

10. The optical camera lens assembly according to claim 1, wherein the at least one spacing piece further comprises a fourth spacing piece and a fifth spacing piece, the fourth spacing piece is positioned between the fourth lens and the fifth lens and is in partial contact with an image-side surface of the fourth lens, and the fifth spacing piece is positioned between the fifth lens and the sixth lens and is in partial contact with an image-side surface of the fifth lens, wherein a maximal thickness CP4 of the fourth spacing piece, a maximal thickness CP5 of the fifth spacing piece, a spacing distance EP45 between the fourth spacing piece and the fifth spacing piece, an effective focal length f4 of the fourth lens, and a refractive index N4 of the fourth lens satisfy:
−0.15<(CP4+EP45+CP5)/(f4*N4)<−0.05.

11. The optical camera lens assembly according to claim 1, wherein the at least one spacing piece further comprises a fifth spacing piece and a fifth spacing piece, the fifth spacing piece is positioned between the fifth lens and the sixth lens and is in partial contact with an image-side surface of the fifth lens, and the sixth spacing piece is positioned between the sixth lens and the seventh lens and is partially against an image-side surface of the sixth lens, wherein a spacing distance EP56 between the fifth spacing piece and the sixth spacing piece, a radius of curvature R12 of the image-side surface of the sixth lens, and a refractive index N6 of the sixth lens satisfy:
−0.5<EP56/(R12*N6)<−0.3.

12. The optical camera lens assembly according to claim 1, wherein the at least one spacing piece further comprises a fifth spacing piece, the fifth spacing piece is positioned between the fifth lens and the sixth lens and is in partial contact with an image-side surface of the fifth lens, wherein an inner diameter d5s of an object-side surface of the fifth spacing piece and a combined focal length f56 of the fifth lens and the sixth lens satisfy: 1.3<d5s/f56<1.6.

13. The optical camera lens assembly according to claim 1, wherein the at least one spacing piece further comprises a sixth spacing piece, the sixth spacing piece is positioned between the sixth lens and the seventh lens and is in partial contact with an image-side surface of the sixth lens, wherein an effective focal length f7 of the seventh lens, a refractive index N7 of the seventh lens, and an inner diameter d6s of an object-side surface of the sixth spacing piece satisfy: −1.3<f7*N7/d6s<−0.8.

14. The optical camera lens assembly according to claim 1, wherein the half of the maximal field-of-view Semi-FOV of the optical camera lens assembly and the maximal height L of the lens barrel satisfy: 0.58≤TAN(Semi-FOV)/L≤0.68.

15. The optical camera lens assembly according to claim 1, wherein the spacing distance EP01 between the object-side end surface of the lens barrel and the first spacing piece, the outer diameter D1s of the object-side surface of the first spacing piece, the effective focal length f1 of the first lens, and the maximal effective radius DT12 of the image-side surface of the first lens satisfy: −2.21≤EP01*D1s/(f1*DT12)≤−1.23.

16. The optical camera lens assembly according to claim 3, wherein the effective focal length f1 of the first lens, the refractive index N1 of the first lens, and the inner diameter d1s of the object-side surface of the first spacing piece satisfy:
−1.45≤f1*N1/d1s<−1.34.

17. The optical camera lens assembly according to claim 4, wherein the spacing distance EP12 between the first spacing piece and the second spacing piece, the center thickness CT2 of the second lens on the optical axis, the spacing distance EP01 between the object-side end surface of the lens barrel and the first spacing piece, and the center thickness CT1 of the first lens on the optical axis satisfy: 1.58<(EP12+CT2)/(EP01+CT1)≤2.13.

18. The optical camera lens assembly according to claim 5, wherein the radius of curvature R1 of the object-side surface of the first lens, the radius of curvature R3 of the object-side surface of the second lens, the maximal effective radius DT11 of the object-side surface of the first lens, and the inner diameter d1s of the object-side surface of first spacing piece satisfy: −0.92≤R1/R3+DT11/d1s≤−0.25.

19. The optical camera lens assembly according to claim 6, wherein the second spacing piece is positioned between the second lens and the third lens and is in partial contact with the image-side surface of the second lens, and the combined focal length f23 of the second lens and the third lens, and the inner diameter d2s of the object-side surface of the second spacing piece satisfy: 1.15≤f23/d2s≤1.23.

20. The optical camera lens assembly according to claim 7, wherein the axial distance SAG32 from the intersection point of the image-side surface of the third lens and the optical axis to the projection point of the effective radius vertex of the image-side surface of the third lens onto the optical axis, and the spacing distance EP23 between the second spacing piece and the third spacing piece satisfy: −0.44≤SAG32/EP23≤−0.39.
